(19) United States
(12) Patent Application Publication
(10) Pub. No.: US 2019/0103030 A1
(43) Pub. Date: Apr. 4, 2019

(54) AERIAL VEHICLE IDENTIFICATION BEACON AND READER SYSTEM

(71) Applicant: Airspace Systems, Inc., San Leandro, CA (US)

(72) Inventors: Jasminder S. Banga, San Francisco, CA (US); Tyler T. Valiquette, Emeryville, CA (US); Guy Bar-Nahum, Sausalito, CA (US); Aislan Gomide Foina, El Cerrito, CA (US)

(21) Appl. No.: 16/142,442

(22) Filed: Sep. 26, 2018

Related U.S. Application Data
(63) Continuation-in-part of application No. 15/839,661, filed on Dec. 12, 2017, now Pat. No. 10,192,451.
Application No. 15/839,661 is a continuation of application No. PCT/US2016/037071, filed on Jun. 10, 2016.
Application No. PCT/US2016/037071 is a continuation-in-part of application No. PCT/US2018/032606, filed on May 14, 2018.
(60) Provisional application No. 62/175,153, filed on Jun. 12, 2015.
(60) Provisional application No. 62/566,450, filed on Oct. 1, 2017.
(60) Provisional application No. 62/566,450, filed on Oct. 1, 2017.
(60) Provisional application No. 62/505,879, filed on May 13, 2017.

(51) Int. Cl. G08G 5/00; B64C 39/02

(52) U.S. Cl. CPC G08G 5/0026; G01S 19/03; B64C 2201/141; B64C 39/024

(57) ABSTRACT

A system for identifying an unmanned aerial vehicle (UAV) detected in a location includes a reader device. The reader device includes a receiver configured to receive identification information transmitted from the UAV, and a transmitter configured to provide the received identification information to an identification server. The identification server includes a memory configured to store UAV registration information associated with the UAV, a receiver configured to receive the identification information provided by the reader device, and a processor configured to provide a verification of the identification information received by the reader based on the provided identification information and the stored UAV registration information.

### CROSS REFERENCE TO OTHER APPLICATIONS

This application is a continuation-in-part of co-pending U.S. patent application Ser. No. 15/839,661 entitled LOW ALTITUDE AIRCRAFT IDENTIFICATION SYSTEM filed Dec. 12, 2017, which is a continuation of International (PCT) Application No. PCT/US2016/037071 entitled A LOW ALTITUDE AIRCRAFT IDENTIFICATION SYSTEM filed Jun. 10, 2016, which claims priority to U.S. Provisional Patent Application No. 62/175,153 entitled LOW ALTITUDE AIRCRAFT IDENTIFICATION SYSTEM filed Jun. 12, 2015 all of which are incorporated herein by reference for all purposes. U.S. patent application Ser. No. 15/839,661 also claims priority to U.S. Provisional Patent Application No. 62/566,450 entitled ENCRYPTION FOR LOW ALTITUDE AIRCRAFT IDENTIFICATION SYSTEMS filed Oct. 1, 2017, which is incorporated herein by reference for all purposes.

This application claims priority to U.S. Provisional Patent Application No. 62/566,450 entitled ENCRYPTION FOR LOW ALTITUDE AIRCRAFT IDENTIFICATION SYSTEMS filed Oct. 1, 2017, which is incorporated herein by reference for all purposes.

This application is a continuation-in-part of and claims priority to International (PCT) Application No. PCT/US2018/032606 entitled SECURE BEACON AND READER SYSTEM FOR REMOTE DRONE AND PILOT IDENTIFICATION filed May 14, 2018, which claims priority to U.S. Provisional Patent Application No. 62/505,879 entitled SECURE BEACON AND READER SYSTEM FOR REMOTE DRONE AND PILOT IDENTIFICATION filed May 13, 2017, both of which are incorporated herein by reference for all purposes.

### BACKGROUND OF THE INVENTION

Related art unmanned aerial vehicles (UAVs) or unmanned aircraft systems (UASs) markets once belonged to professional companies. However, related art UAVs and UASs now include amateur pilots flying affordable models available for purchase, for example, in an electronic store, and which may be controlled by mobile communication devices such as smartphones. However, these related art flying objects may cause damage and/or injury due to their altitude, speed and weight. Further, it is also possible that a UAS may be used for acts of terrorism, criminal activity, or espionage. Thus, there is a need to manage the related art UAVs and UASs.

In ground-based systems, such as the related art automotive market, one of the bases of the car control system, may include an identification credential issued by a division of motor vehicles (DMV) or others, such as a license plate. However, there is no analogous identification method or system for related art UAVs and/or UASs. Currently, the FAA requires sUASs to identify themselves by replicating the ID system used on aircrafts (i.e.: “Tail Numbers”). This is a static, antiquated, and easily defeated identification system. For related art small UASs (e.g., aircrafts up to 25 pounds flying up to 500 ft of the low altitude airspace), tail numbers that are used in commercial aircraft are too large in size (e.g., area) to be provided on these vehicles, or they will be too small to allow the small UAS identification.

Related art systems do not fully address the necessary demands of an identification scheme that permits ground-level identification, as well as identification by other aircrafts of various sizes and altitudes as may be required by the growth of sUAS systems. Related art systems also do not fully address the need for a solution that allows detection in an automated way by a device.

### BRIEF DESCRIPTION OF THE DRAWINGS

Various embodiments of the invention are disclosed in the following detailed description and the accompanying drawings.

FIGS. 1-8 illustrate schematic representations of an Identify Friend or Foe System in accordance with example implementations of the present application.

FIGS. 9-12 illustrate user interfaces (UI) in accordance with example implementations of the present application.

FIGS. 13-18 illustrate flow diagrams of processes in accordance with example implementations of the present application.

FIG. 19A illustrates a perspective view of a beacon in accordance with an example implementation of the present application.

FIG. 19B illustrates a perspective view of an IFF reader/interface unit in accordance with an example implementation of the present application.

FIGS. 20A and 20B illustrate images of a beacon in accordance with example implementations of the present application.

FIG. 21 illustrates an example computing environment with an example computer device suitable for use in some example implementations of the present application.

FIG. 22 is a block diagram illustrating an embodiment of a system for vehicle identifier authentication.

FIG. 23 is a flowchart illustrating an embodiment of a process for generating an authenticatable identifier to be broadcasted.

FIG. 24 is a flowchart illustrating an embodiment of a process for verifying an authenticity of a transmitted authenticatable identifier.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Aspects of the example implementations are directed to methods and systems for identification of airborne objects at a low altitude, and more specifically, to systems and methods for identification of low-altitude aircraft.

Aspects of the present application may relate to a system for identifying an unmanned aerial vehicle (UAS). The system may include a reader having a receiver configured to receive identification information, and a transmitter configured to re-transmit the received identification information; and an identification server having a memory storing UAS registration information, a receiver configured to receive transmissions, a transmitter to transmit information and a processor configured to provide a verification of the identification information received by the reader based on the re-transmitted identification information and the stored UAS registration.

Additional aspects of the present application may relate to a non-transitory computer readable medium having stored therein a program for making a computer execute a method of identifying an unmanned aerial vehicle (UAS) detected in a location. The method may include receiving, by a reader, identification information transmitted from the UAS; and comparing received identification information to stored UAS registration information associated with the UAS; and providing, by a server, a verification of the identification information based on a result of the comparison of the re-transmitted identification information and the stored UAS registration.

Further aspects of the present application relate to a method of identifying an unmanned aerial vehicle (UAS) detected in a location. The method may include receiving, by a reader, identification information transmitted from the UAS; and comparing received identification information to stored UAS registration information associated with the UAS; and providing, by a server, a verification of the identification information based on a result of the comparison of the re-transmitted identification information and the stored UAS registration.

Still further aspects of the present application relate to a computer apparatus configured to identify an unmanned aerial vehicle (UAS) detected in a location. The computer apparatus may include means for receiving identification information transmitted from the UAS; means for comparing received identification information to stored UAS registration information associated with the UAS; means for providing, by a server, a verification of the identification information based on a result of the comparison of the re-transmitted identification information and the stored UAS registration.

The proliferation of small unmanned aerial vehicles (sUAS) in domestic US airspace is rapidly increasing and with it the need to effectively enforce rules and regulations governing their safe operation. How these rules and regulations are applied will vary between individuals and organizations depending on permissions that have been granted by those responsible for the airspace in which the sUAS is flying. As with any permit-contingent regulation, effective enforcement of these rules depends on the ability of nearby observers to ascertain the identity of the pilot and aircraft and determine whether or not they are permitted to operate in the specific airspace in which the sUAS they are flying is observed.

As discussed above, existing sUAS identification systems do not provide an optimal experience and there may be an industry need for a new identification system that can drive sUAS adoption globally. Example implementations of the present application may include an Identify Friend or Foe (IFF) system that may overcome some or all of the problems with the related art systems. Example implementations of the present application may enable observers to positively identify a sUAS and pilot using simple and intuitive components based on current consumer electronics. Example implementations of the present application may provide a system is globally interoperable, incorporates bank-level verification, and can be operated reliably anywhere there is cellphone coverage. Further, some example implementations may rely on locally stored databases of regularly provisioned ID, pilot, sUAS, mission, etc., information to allow operation with only intermittent communication (e.g., no cellular coverage may be required.

Example implementations may be constructed from low-cost components, enabling anyone, from a private citizen to a multinational corporation, to determine who is flying in the air above them and to directly contact the pilot if desired, all while protecting the privacy of all parties.

In some example implementations, the system may be implemented by integrating an IFF identification code into an ADS-B transponder that may append a unique IFF identifier to the code typically sent out by the ADS-B. This may allow the IFF information to be received by an ADS-B receiver or reader device.

Thus, the System may enable the safe and permitted operation of authorized sUASs in private and controlled airspaces by providing its operator with the ability to identify any sUAS as a friendly or otherwise. Example implementations of such a system may rely on secure air-to-ground communication and can verify whether the sUAS in question is authorized to be flying in any given airspace. Example uses of the IFF System may include:
1. Commercial and government entities that want to protect their airspace and have a way to mitigate any potential threats from sUASs. The same entities may employ their own sUAS for enterprise or governmental use, and the system allows easy identification of these sUAS to avoid mitigating a friendly sUAS.
2. Individuals or entities that wish to allow sUASs to enter their airspace for sightseeing, and want to communicate with the sUAS operator for revenue generation.
3. Individuals or entities that want to identify a specific sUAS for privacy and/or personal interest purposes.

By providing a capability to identify and verify who is piloting an sUAS (and who is the owner of said sUAS) within a specific airspace, example implementations of the present application may provide a solution for regulating the regions around secure facilities or public venues and in some implementations may also allow owners to commercialize travel there through. Further, the ability to regulate regions of airspace may become increasingly important as sUAS systems become more prevalent.

As an example implementations, a beacon to be mounted on a sUAS to interact with an IFF system may be rented out (or a unique, registered code may be provided to a beacon already mounted on the sUAS) by an organization as part of sale or rental of access to restricted airspace in locations where no network may exist. For example, the National Park Service may sell time-limited permit codes (or rent out a beacon) to allow people to photograph Yosemite Valley as part of a revenue generating opportunity enable by an IFF system.

As another example without an effective IFF solution in place many sports stadiums may prohibit the use of any drones to capture footage of sporting events. However, with an IFF system implemented, stadium operators or sports associations may issue permits or registrations to certain companies (broadcasters, etc.) as part of selling aerial footage capture rights for potentially substantial value. An IFF system may allow the differentiation of the drones that have access rights from drones that are trespassing, and the trespassing drones can be removed, disabled or destroyed while the authorized drones can proceed without interruption. Other example implementations may have other potential uses that might be apparent to a person of ordinary skill in the art.

Further, subsequent to identification and verification, example implementations of the present application may also provide or be coupled with systems that may provide interdiction with “trespassing” sUAS to minimize or neutralize any potential threats. For example, soft interdiction may be performed by issuing an exclude signal instructing any unauthorized sUAS to vacate a controlled area to avoid direct interdiction. Further, hard interdiction may be performed by capturing, disabling, or destroying the unauthorized sUAS via a ground-based or air-based interdiction platform (e.g., ground-based capture, disable, or destruction system; a deployable sUAS having an onboard interdiction system capable of capturing, disabling, or destroying the unauthorized sUAS). For example, a patrol sUAS capture and control capabilities may ensnare the unauthorized sUAS and move it out of the controlled area. Electronic hard mitigation systems may also be deployed (e.g., radio frequency jamming or hacking of the command and control (C2) link).

Multiple example implementations of the present application are discussed below for explanatory purposes. Discussion of specific components as part of one example implementation is not intended to convey that those components are limited to that example implementation; any of the discussed components may be combined or incorporated into other example implementations as may be apparent to a person of ordinary skill in the art. Further, any reference to a specific component, part, model, or other aspect of any example implementation should not be interpreted as limiting any example implementation to that specific component, part, model, or aspect and equivalent components, parts, models, or aspects may be incorporated into example implementations without departing from the nature of the application as may be apparent to a person of ordinary skill in the art.

In the present application, the terms “sUAS”, “aerial platform”, “aerial vehicle”, “aerial drone”, or “drone” may be used interchangeably and any specific usage is not intended to limit or exclude any of the other terms. Further, in the present application, the terms “operator”, “owner”, “pilot”, or “user” may be used to describe roles of individuals interacting with example implementations of the present application. However, an individual may fill/occupy multiple roles when interacting with example implementations and may move from one role in one situation to another in a different situation. Further, use of one of these terms in relation to an example implementation of the present application is not intended to limit example implementations to only allow interaction with an individual in that role and other roles may similarly interact with example implementations of the present application as may be apparent to a person of ordinary skill in the art.

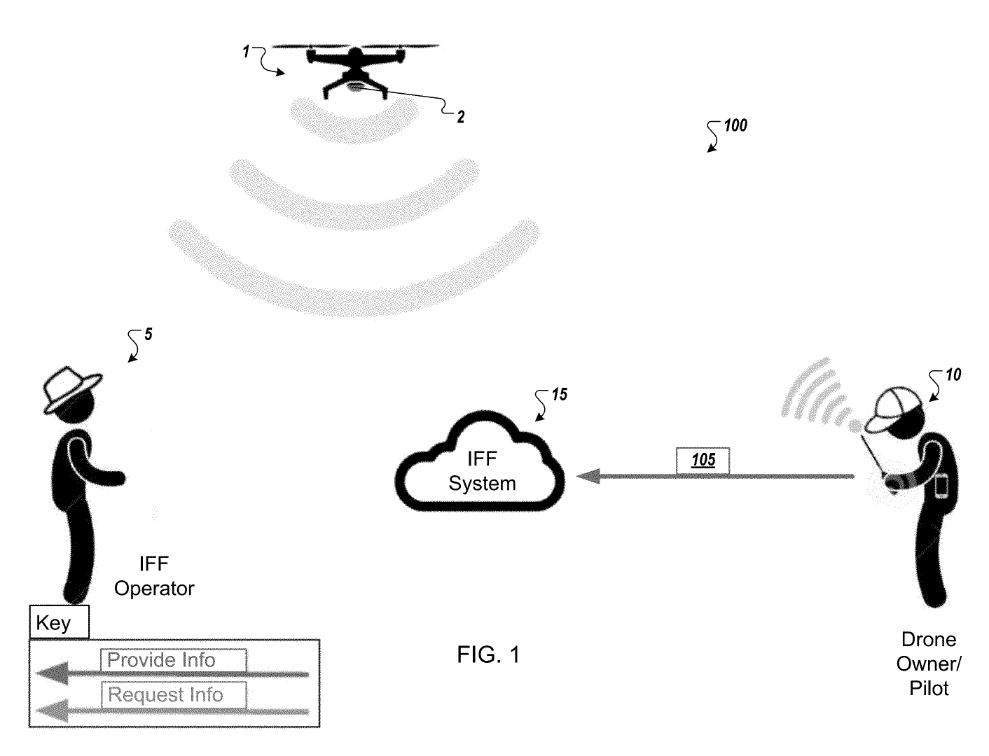

FIGS. 1-4 illustrate a schematic representation 100 of a system in accordance with an example implementation of the present application. As illustrated, a drone 1 may be operated by an owner or pilot 10 in a location. The location may be a public location (such as a park, forest, garden, or any other location that might be apparent to a person of ordinary skill in the art), a private location (such as a private residence, a corporate location, a private golf course, or any other location that might be apparent to a person of ordinary skill in the art), a secured location (such as a power plant, a military base, a government facility or any other location that might be apparent to a person of ordinary skill in the art) or any other type of location that might be apparent to a person of ordinary skill in the art. Further, the location does not need to be a fixed location and instead, the owner or pilot 10 may be in a mobile location (e.g., a vehicle such as a car, truck, boat, ship, or other mobile platform that might be apparent to a person of ordinary skill in the art).

In example implementations, the drone 1 is not particularly limited and may include a quadcopter, hexacopter, octocopter, helicopter a fixed wing drone, or any other type of air maneuverable drone that may be apparent to a person of ordinary skill in the art. Further, in some example implementations, the drone may be ground-based (e.g., car, truck, tracked drone, or any other ground drone that might be apparent to a person of ordinary skill in the art. Similarly, in some example implementations, the drone may be water-based (e.g., a boat, submarine, hovercraft or other water drone that might be apparent to a person of ordinary skill in the art. The drone 1 may be controlled by the pilot/owner 10 using a cellular signal, radiofrequency signal, Bluetooth signal, line-of-sight laser signal or any other wireless signal that may be apparent to a person of ordinary skill in the art. Further, the drone 1 may include an identification beacon 2 that may be either integrated into the drone itself by the drone manufacturer or added as an aftermarket module by the owner/pilot 10.

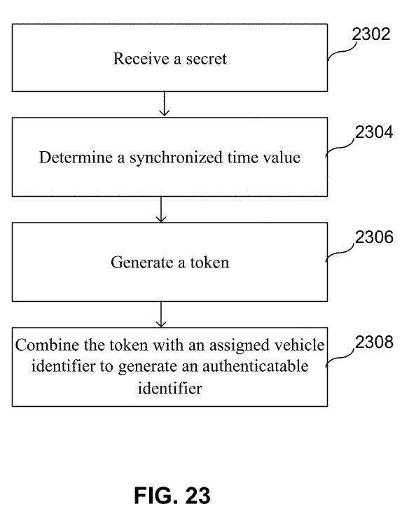

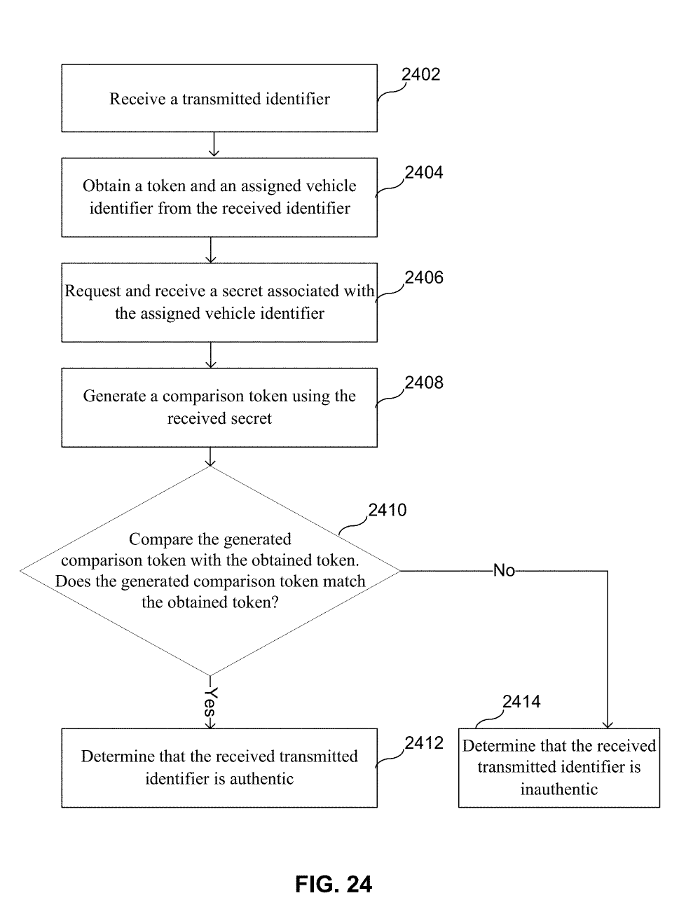

The beacon 2 may be a small, self-contained wireless transmitting device that is registered with a database that is part of the IFF system 15. In some example implementations, the beacon 2 may broadcast an encrypted signature using SSL certificates that are unique to each beacon that enables the rest of the IFF System 15 to identify the drone and verify whether it is permitted to fly in any given airspace. In some embodiments, beacon 2 broadcasts a changing identifier using at least a portion of the process of FIG. 23. For example, beacon 2 broadcasts a new authenticable identifier (e.g., Service Set Identifier (SSID)) generated using a periodic execution of the process of FIG. 23. The SSID may conform to the IEEE 802.11 wireless standard and the SSID may be utilized to identify the aircraft and also can be used to establish a wireless communication with the aircraft. In some embodiments, the SSID includes a unique identifier of the aircraft as well as a token that can be used by the receiver to verify that the SSID is a valid SSID of the aircraft. To increase security of the SSID and prevent another aircraft from replaying the SSID, the token included in the SSID may dynamically change over time, resulting in an SSID that when replayed at a later time is no longer valid. In some embodiments, this authenticable identifier is authenticated using at least a portion of the process of FIG. 24. For example, IFF interface unit 4 or IFF fixed station 3 executes the process of FIG. 24 to authenticate the authenticable identifier. As discussed in greater detail below, the beacon 2 may include a housing, battery, microcontroller with support electronics, a charging port, and antenna for sending and receiving wireless signals (Wi-Fi, cellular, satellite communication, ZigBee, Bluetooth, or any other wireless frequency or protocol that might be apparent to a person of ordinary skill in the art). As an aftermarket device, the beacon 2 may be mounted onto any drone using either a generic mounting system or one designed specifically for the most common drones (e.g. DJI Phantom, 3DR Solo, DJI Inspire).

Additionally, the beacon 2 may include three layers or components: 1. A data link layer that may be implemented by Wi-Fi, cellular, satellite communication, ZigBee, Bluetooth, or any other wireless frequency or protocol that might be apparent to a person of ordinary skill in the art; 2. An authentication layer that may implement encrypted identification information and/or provide two-way authentication; and 3. a telemetry layer that may provide location information or other onboard senor data. The information may also include other pilot/owner selected and specified information—e.g. drone type, company, mission, social media feed, contact information or any other information that might be apparent to a person of ordinary skill in the art.

During operation, the drone 1 may be observed by a third-party operator/observer 5, who is located in a general vicinity of the drone 1. Though the operator/observer 5 may be in a general vicinity of the drone 1, the operator/observer 5 may be very distant from the drone owner/pilot 10 as the signal range for the communication between the owner/pilot 10 and the drone 1 may be quite large. Thus, without some sort of system to identify the drone 1 and/or the drone's owner/pilot 10, the observer/operator 5 is unable to determine whether the drone 10 is authorized to be at the location and/or the drone's purpose creating a knowledge gap. The IFF system 15 according to an example implementation of the present application may seek to fill that knowledge gap as discussed below.

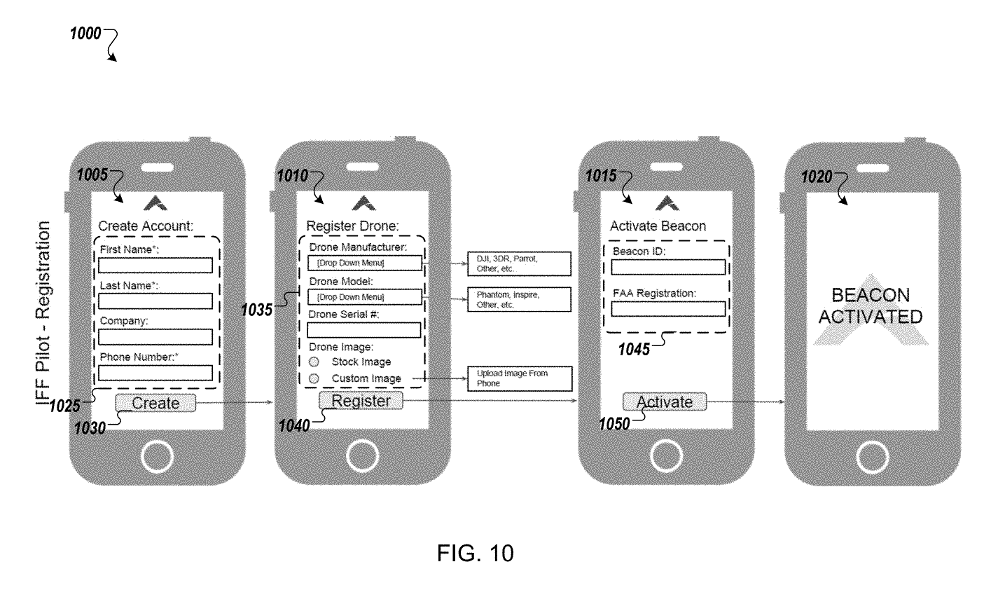

As illustrated in FIG. 1, as an initial matter the drone owner/operator 10 may register the drone 1 with the IFF system 15 using communication 105. The owner/operator 10 may use a mobile application on a mobile computing device or may use a web-based registration form to provide the IFF system 15 with registration information. The registration information may include identification information for the drone 1 (e.g., manufacturer, model, manufacture date, etc.) and identification information for the beacon 2 (e.g., identification number or identification card). The registration information may also include identification information for the drone owner/pilot 10 (e.g., name, address, phone number, email address, etc.). The registration process is discussed in greater detail below with respect to the user interfaces of FIG. 10.

In some example implementations, the pilot/owner may also have an option to control whether the registered information is publically available and optionally, to provide redacted information that will be publically available as an alternative to the registered information. For example, a pilot/owner may use a private, personal email address for registration purposes, but provide a different, corporate a use-specific address to be publically listed.

In some implementations, the owner/operator 10 may not pre-register the information using communication 105 but the identification information for the drone 1, the beacon 2, and the drone owner/pilot 10 may be provided to the IFF system 15 in real time using communication 105 while the drone owner/pilot 10 is operating the drone 1.

The IFF system 15 may include a database to store received information and a backend to facilitate communications between the IFF system and other parties and provide information stored in the database to authorized requesters. The database may be a proprietary database set-up for operation by corporate clients, a public database maintained by a third party, or a combination of both. The database may contain confidential sUAS information such as unique identifiers, sUAS data, registered flight plans, airspace access permissions, purchased permits, social media connections, FAA registrations, sUAS owner (private or corporate), and pilot information. This database is kept up to date on a remote server for ease of access wherever internet is available. The database may be periodically downloaded to a Smartphone Application or other software program for use when data connection is unavailable, for offline use. Further the database may also be stored locally on the beacon by the owner/pilot and transmitted to the observer when the observer is unable to connect to the internet.

Further, the wireless communication signal 105 may be a Wi-Fi, cellular, satellite communication, ZigBee, Bluetooth, a direct line-of-sight laser signal, or any other wireless frequency or protocol that might be apparent to a person of ordinary skill in the art.

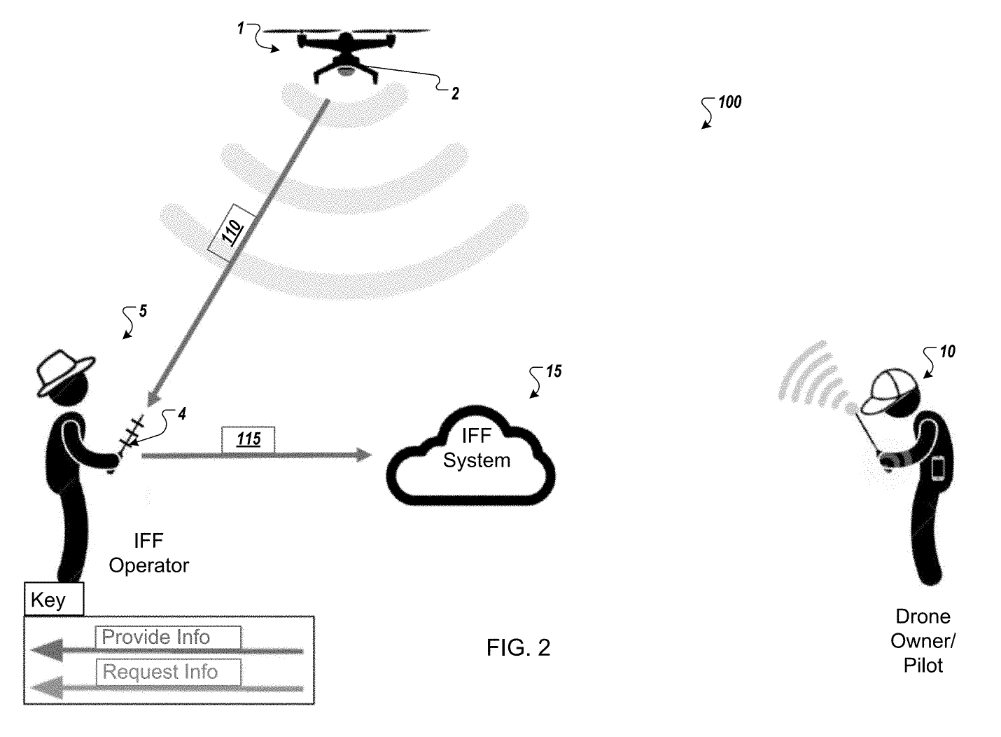

As illustrated in FIG. 2, the operator/observer 5 may use a handheld IFF interface unit 4 to wirelessly communicate with the beacon 2. In some example implementations the IFF interface unit 4 may be an IFF specific mobile device designed to interact with the IFF system and registered secure beacons such as the beacon 2. In other example implementations, the IFF interface unit 4 may be the operator/observer's 5 personal communications device (e.g. smart phone, tablet, smart watch etc.) running a software program or mobile application (e.g., an IFF Smartphone app) designed to interface with the IFF system 15.

The IFF interface unit may include the following components or layers: 1. Data link layer that may facilitate data exchange with both the drone 1 (or the beacon 2 mounted on the drone 1) and the Internet/cloud-based network may be implemented by Wi-Fi, cellular, satellite communication, ZigBee, Bluetooth, or any other wireless frequency or protocol that might be apparent to a person of ordinary skill in the art; 2. An Authentication layer that may provide one-way or two-way authentication; and 3. a data storage layer that may store a local copy of the IFF database, archived data frames, uploaded policy data, or any other information necessary for the operation of the IFF interface unit 4. In some example implementations, another layer may be provided for information to be transmitted to the pilot/owner via the drone (e.g., “you are in a secure airspace, please depart immediately”, or any other communication message that might be apparent to a person of ordinary skill in the art.)

The IFF Smartphone App or software program may be compatible with all latest generation smartphones, either natively or through a web application. Using the onboard RF antenna, the app may receive transmissions via Wi-Fi, cellular, satellite communication, ZigBee, Bluetooth, or any other wireless frequency or protocol that might be apparent to a person of ordinary skill in the art from the IFF Beacon which it cross-references with an IFF Database. The App may then display an augmented reality user interface incorporating any publicly available drone and pilot information associated with the IFF Beacon over the smartphone camera view as discussed below. Through the app the user may access any relevant/available pilot and sUAS data contained in the database as well as the ability to contact the pilot anonymously if so desired.

In some example implementations, the IFF interface unit 4 may also include an IFF receiver. The IFF Receiver may be a compact handheld device capable of extending the effective range of the IFF Smartphone App running on a mobile device. The receiver may be comprised of a housing, battery, microcontroller with support electronics, Bluetooth receiver, wire connections for data and/or power, and single directional communication antenna (and potentially a high powered camera). The receiver may operate using Wi-Fi, cellular, satellite communication, ZigBee, Bluetooth, or any other wireless frequency or protocol that might be apparent to a person of ordinary skill in the art. The receiver may pair with a mobile device (e.g., a large-screen, latest generation smartphone or mini tablet) and provides an ergonomic platform for aiming and operating the smartphone app.

In some example implementations, the beacon 2 may broadcast encrypted identification information (optionally including current location based on GPS information or other location information). This transmission may use bank-level encryption, transmitted over 2.4 GHz radio link or any other data link that might be apparent to a person of ordinary skill in the art, and can be received by IFF interface unit 4. Due to the two-way authentication at the data transmission level, the information from the drone 1 may be trusted as coming from the drone 1.

For example, with the IFF interface unit 4, the operator/observer 5 may receive an encrypted code or identification number from the beacon 2 mounted on the drone 1 via wireless communication signal 110. The encrypted code or identification number and optional GPS location may be transmitted by the beacon 2 once per second, or at any interval that might be apparent to a person of ordinary skill in the art.

Once the operator/observer 5 receives the encrypted code or identification number from the beacon 2, the operator/observer 5 may provide the encrypted code or identification number to the IFF system 15 using wireless communication signal 115 along with the request for verification that the drone 1 is authorized to be at this specific location and/or contact information of the drone owner/pilot 10. Again, either of the wireless communication signals 110, 115 may be a transmission using Wi-Fi, cellular, satellite communication, ZigBee, Bluetooth, a direct line-of-sight laser signal, or any other wireless frequency or protocol that might be apparent to a person of ordinary skill in the art.

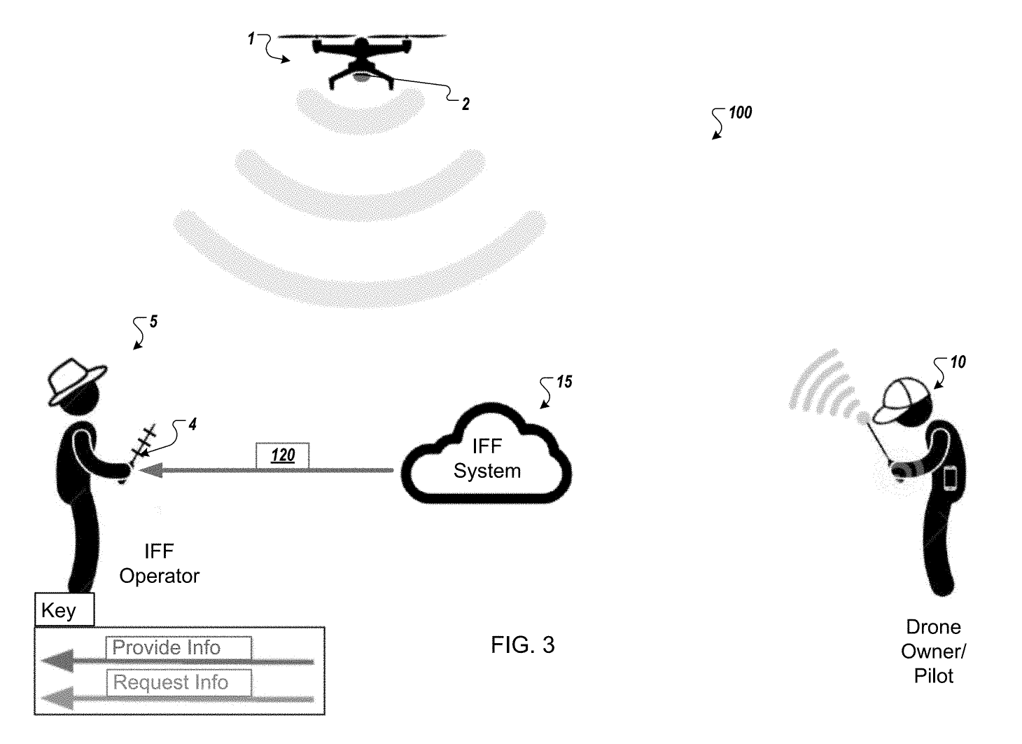

As illustrated in FIG. 3, the IFF system 15 may reply to the wireless communication signal 115 with identification information transmitted through wireless communication signal 120. In some example implementations, the identification information may include a notification that the drone 1 has preauthorization to be in the location as well as an explanation of the intended purpose for its presence. In other example implementations, the identification information may additionally or alternatively include identification information which may identify and/or allow communications with the drone owner/pilot 10. For example, the identification information may include the drone owner/pilot's 10 name, phone number, email address, social media username, or any other information that may be used to identify and/or contact the drone owner/pilot 10.

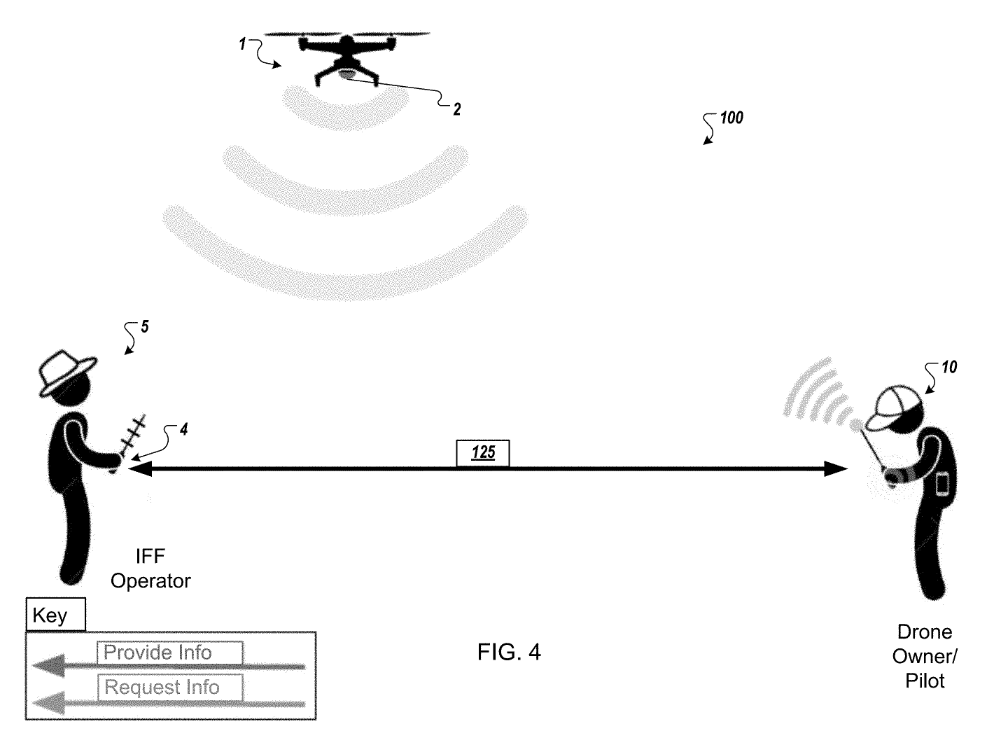

As illustrated in FIG. 4, after receiving the identification information by the wireless communication signal 120, the operator/observer 5 may send a communication signal 125 to the drone owner/pilot 10 to confirm that he is actually piloting the drone 1 associated with the beacon 2. This may provide a second factor of authentication to allow confirmation that not only is the specific drone 1 authorized to be in a specific location, but that the registered owner/pilot is operating the drone and the registered drone has not been commandeered by a rogue pilot. The communication signal 125 may be an email, an application based communication sent through shared communication platform (either incorporated as part of the IFF system or a third-party communications platform such as an instant message platform, social media platform etc.), a short messaging system (SMS) communication, a voice over IP (VOIP) communication, a telephonic call using telephone infrastructure (e.g. cellular network or hardline), a message or other communication uploaded to the beacon and downloaded to the owner/pilot via a data connection with the beacon or any other communication that may be apparent to a person of ordinary skill in the art.

Once the operator/observer 5 is satisfied that the drone 1 associated with the beacon 2 is authorized and operated in accordance with applicable flight restrictions/access guidelines the communication signal 125 may be terminated. The observer/operator 5 and the drone owner/pilot 10 may go about their respective activities. Alternatively, if the operator/observer 5 is not satisfied that the drone 1 associated with the beacon 2 or is not operated in accordance with applicable flight restrictions/access guidelines, the operator/observer 5 may take responsive action by initiating or requesting interdiction (e.g. soft interdiction or hard interdiction) of the drone 1 or reporting it to authorities such as FAA, Police, etc. Example implementations of this interdiction may be discussed in greater detail below.

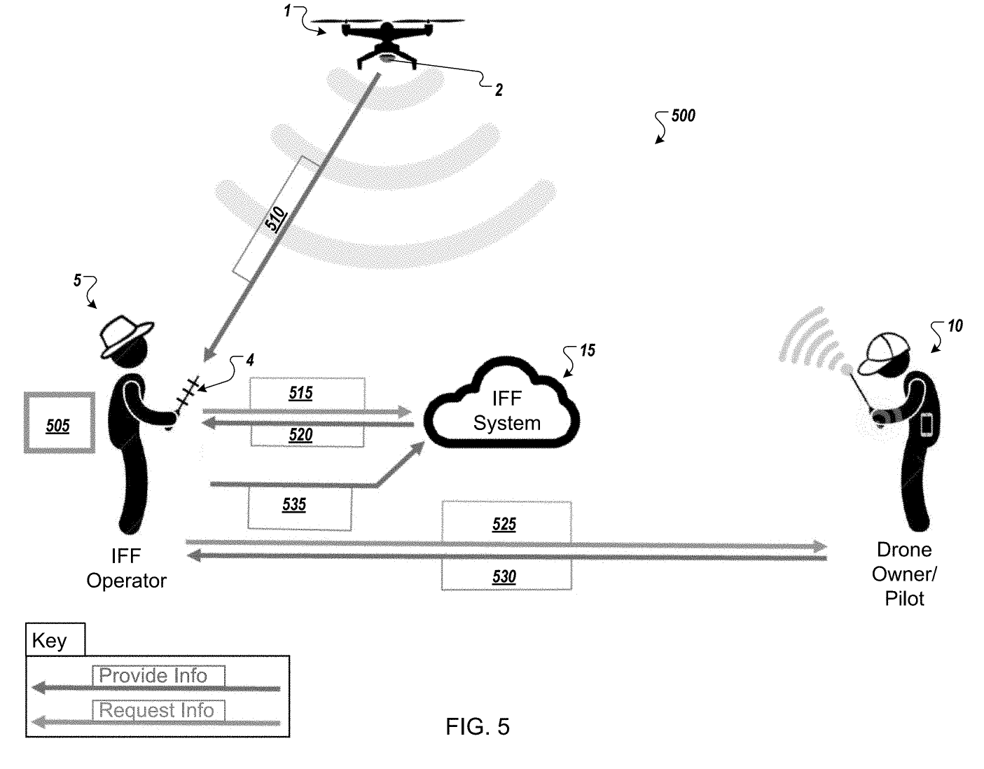

FIG. 5 illustrates a schematic representation 500 of a system in accordance with another example implementation of the present application. Some aspects of the schematic representation 500 may be similar to aspects of the schematic representation 100 of FIGS. 1-4. Thus, similar description and reference numerals may be provided. Again, a drone 1 may be operated by an owner or pilot 10 in a location. The location may be a public location (such as a park, forest, garden, or any other location that might be apparent to a person of ordinary skill in the art), a private location (such as a private residence, a corporate location, a private golf course, or any other location that might be apparent to a person of ordinary skill in the art), a secured location (such as a power plant, a military base, a government facility or any other location that might be apparent to a person of ordinary skill in the art) or any other type of location that might be apparent to a person of ordinary skill in the art.

Further, the drone 1 again may include an identification beacon 2 that may be either integrated into the drone itself by the drone manufacturer or added as an aftermarket module by the owner/pilot 10. The beacon 2 may be a small, self-contained wireless transmitting device that is registered with a database that is part of the IFF system 15. For example, the beacon 15 may broadcast an encrypted signature using SSL certificates that are unique to each beacon that enables the rest of the IFF System 15 to identify the drone and verify whether it is permitted to fly in any given airspace. As discussed in greater detail below, the beacon 2 may include a housing, battery, microcontroller with support electronics, a charging port, and antenna for sending and receiving wireless signals (e.g., Wi-Fi, cellular, satellite communication, ZigBee, Bluetooth, or any other wireless frequency or protocol that might be apparent to a person of ordinary skill in the art). As an aftermarket device, the beacon 2 may be mounted onto any drone using either a generic mounting system or one designed specifically for the most common drones (e.g. DJI Phantom, 3DR Solo, DJI Inspire).

Again, the drone 1 may be observed by a third-party operator/observer 5, who is located in a general vicinity of the drone 1. Though the operator/observer 5 may be in a general vicinity of the drone 1, the operator/observer 5 may be very distant from the drone owner/pilot 10 as the signal range for the communication between the owner/pilot 10 and the drone 1 may be quite large. The IFF system 15 according to an example implementation of the present application may seek to allow the observer/operator 5 to verify and validate the authorization of the drone to access the location.

The IFF system 15 may include a database to store registration information received from the drone owner/pilot 10 and a backend to facilitate communications between the IFF system and other parties and provide information stored in the database to authorized requesters. The database may be a proprietary database set-up for operation by corporate clients, a public database maintained by a third party, or a combination of both. The database may contain confidential sUAS information such as unique identifiers, sUAS data, registered flight plans, airspace access permissions, purchased permits, social media connections, FAA registrations, sUAS owner (private or corporate), and pilot information. This database is kept up to date on a remote server for ease of access wherever internet is available. The database may be periodically downloaded to a Smartphone Application or other software program for use when data connection is available, for offline use.

The registration information may be provided using a mobile application on a mobile computing device or may use a web-based registration form to provide the IFF system 15 with registration information. The registration information may include identification information for the drone 1 (e.g., manufacturer, model, manufacture date, etc.) and identification information for the beacon 2 (e.g., identification number or identification card). The registration information may also include identification information for the drone owner/pilot 10 (e.g., name, address, phone number, email address, etc.). The registration process is discussed in greater detail below with respect to the user interfaces of FIG. 10.

The backend of the IFF system 15 may facilitate communication using wired or wireless signals such as a Wi-Fi, cellular, satellite communication, ZigBee, Bluetooth, a direct line-of-sight laser signal, or any other type of wireless signal that may be apparent to a person of ordinary skill in the art.

As illustrated in FIG. 5, the operator/observer 5 may use a handheld IFF interface unit 4 to wirelessly communicate with the beacon 2 at 505. In some example implementations the IFF interface unit 4 may be an IFF specific mobile device designed to interact with the IFF system and registered secure beacons such as the beacon 2. In other example implementations, the IFF interface unit 4 may be the operator/observer's 5 personal communications device (e.g. smart phone, tablet, smart watch etc.) running a software program or mobile application designed to interface with the IFF system 15.

The IFF Smartphone App or software program may be compatible with all latest generation smartphones, either natively or through a web application. Using the onboard RF antenna, the app may receive transmissions (e.g., Wi-Fi, cellular, satellite communication, ZigBee, Bluetooth, or any other wireless frequency or protocol that might be apparent to a person of ordinary skill in the art) from the IFF Beacon which it cross-references with an IFF Database. The App may then display an augmented reality user interface incorporating any publicly available drone and pilot information associated with the IFF Beacon over the smartphone camera view as discussed below. Through the app the user may access any relevant/available pilot and sUAS data contained in the database as well as the ability to contact the pilot anonymously if so desired.

In some example implementations, the IFF interface unit 4 may also include an IFF receiver. The IFF Receiver may be a compact handheld device capable of extending the effective range of the IFF Smartphone App running on a mobile device. The receiver may be comprised of a housing, battery, microcontroller with support electronics, Bluetooth receiver, and single directional communication (e.g., Wi-Fi, cellular, satellite communication, ZigBee, Bluetooth, or any other wireless frequency or protocol that might be apparent to a person of ordinary skill in the art) antenna (and potentially a high powered camera). The receiver may pair with a mobile device (e.g., a large-screen, latest generation smartphone or mini tablet) and provides an ergonomic platform for aiming and operating the smartphone app.

With the IFF interface unit 4, the operator/observer 5 may receive an encrypted code or identification number from the beacon 2 mounted on the drone 1 via wireless communication signal 510.

Once the operator/observer 5 receives the encrypted code or identification number from the beacon 2, the operator/observer 5 may provide the encrypted code or identification number to the IFF system 15 using wireless communication signal 515 along with the request for verification that the drone 1 is authorized to be at this specific location and/or contact information of the drone owner/pilot 10.

The IFF system 15 may reply to the wireless communication signal 515 with identification information transmitted through wireless communication signal 520. In some example implementations, the identification information may include identification information which may identify and/or allow communications with the drone owner/pilot 10. For example, the identification information may include the drone owner/pilot's 10 name, phone number, email address, social media username, or any other information that may be used to identify and/or contact the drone owner/pilot 10.

After receiving the identification information by the wireless communication signal 520, the operator/observer 5 may send a communication signal 525 to the drone owner/pilot 10 to confirm that he is actually piloting the drone 1 associated with the beacon 2. In order to provide more enhanced security, the communication signal 525 may also include a command code request or other verification scheme to which a reply signal 530 will be required in order to validate the drone owner/pilot 5 as the registered drone owner/pilot.

In some example implementations, the reply signal 530 may include a required/requested PIN, password or other validation code that may verify that the replying party is the registered owner/pilot. This may provide a second factor of authentication to allow confirmation that not only is the specific drone 1 authorized to be in a specific location, but that it is being piloted or flown by the registered owner/pilot and has not been commandeered by a rogue pilot who is impersonating the authorized pilot/owner. In other words, the owner/pilot is verified not only by being reachable using the registered contact information but also by providing the PIN, password, or validation code associated with the drone 1. In some example implementations, the second factor of authentication may be provided by detecting location information (e.g., GPS, etc.) associated with a device (e.g., a phone, tablet, etc.) associated and co-located with the owner/pilot as a proxy for authentication (e.g., if the pilot is located at the same location of the drone, he must be piloting, or he must be ok).

Once the operator/observer 5 is satisfied that the drone 1 associated with the beacon 2 is authorized and operated in accordance with applicable flight restrictions/access guidelines the inquiry of the operator/observer 5 may be terminated. The observer/operator 5 and the drone owner/pilot 10 may go about their respective activities. Alternatively, if the operator/observer 5 is not satisfied that the drone 1 associated with the beacon 2 or is not operated in accordance with applicable flight restrictions/access guidelines, the operator/observer 5 may take responsive action by initiating or requesting interdiction (e.g. soft interdiction or hard interdiction) of the drone 1. Example implementations of this interdiction may be discussed in greater detail below.

In FIG. 5, the observer/operator 5 also has the ability to send a report or update 535 to the IFF system 15. For example, the observer/operator 5 may report that the drone 1 was flying dangerously, hovering in intrusive locations or otherwise violating flight/access standards. The report or update 535 may also include an indication that the drone 1 has been commandeered or been stolen. The IFF system 15 may store the report or forward to another party to act upon.

In the example implementations of FIGS. 1-5, the observer/operator 5 may interface directly with the drone owner/pilot 10 through communications 125/525/530. However, in certain situations either the observer/operator 5 and/or drone owner/pilot 10 may wish to not directly interface with the other. This may be a safety concern, a privacy concern, or merely a personal preference. The following embodiments may allow the IFF system 15 or some other third party system to provide a barrier.

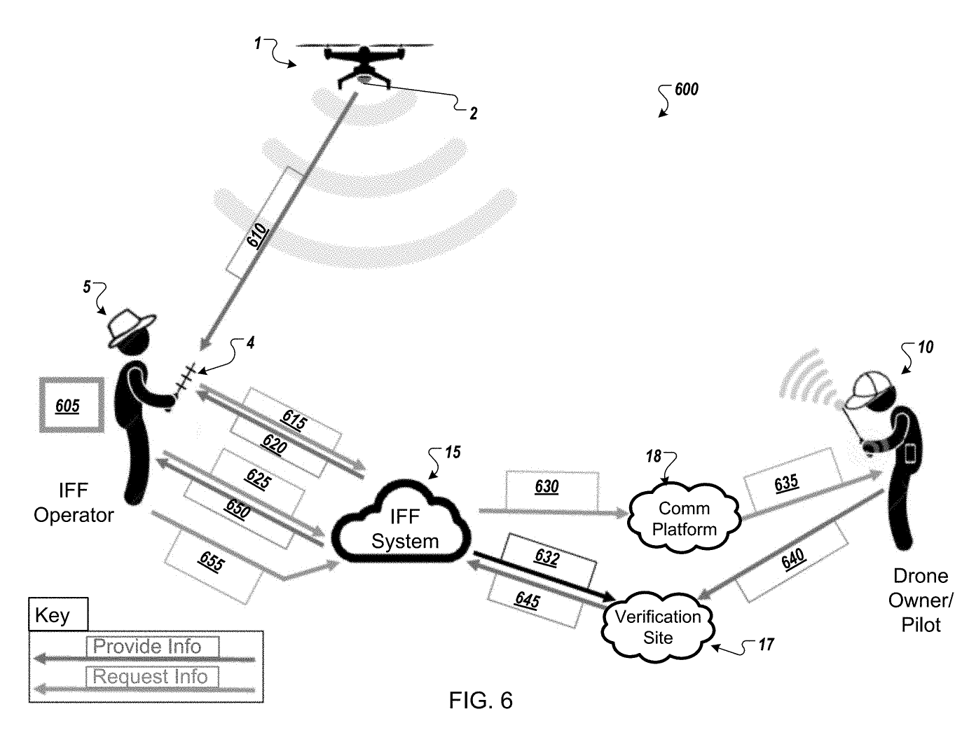

FIG. 6 illustrates a schematic representation 600 of a system in accordance with another example implementation of the present application. Some aspects of the schematic representation 600 may be similar to aspects of the schematic representations 100 and 500 of FIGS. 1-5. Thus, similar description and reference numerals may be provided. Again, a drone 1 may be operated by an owner or pilot 10 in a location (e.g., a public location, a private location, a secured location, etc.) or any other type of location that might be apparent to a person of ordinary skill in the art.

Further, the drone 1 again may include an identification beacon 2 that may be either integrated into the drone itself by the drone manufacturer or added as an aftermarket module by the owner/pilot 10. The beacon 2 may be a small, self-contained wireless transmitting device that is registered with a database that is part of the IFF system 15. For example, the beacon 15 may broadcast an encrypted signature using SSL certificates that are unique to each beacon that enables the rest of the IFF System 15 to identify the drone and verify whether it is permitted to fly in any given airspace.

Again, the drone 1 may be observed by a third-party operator/observer 5, who is located in a general vicinity of the drone 1. Though the operator/observer 5 may be in a general vicinity of the drone 1, the operator/observer 5 may be very distant from the drone owner/pilot 10 as the signal range for the communication between the owner/pilot 10 and the drone 1 may be quite large. The IFF system 15 according to an example implementation of the present application may seek to allow the observer/operator 5 to verify and validate the authorization of the drone to access the location.

The IFF system 15 may include a database to store confidential sUAS information such as unique identifiers, sUAS data, registered flight plans, airspace access permissions, purchased permits, social media connections, FAA registrations, sUAS owner (private or corporate), and pilot information. This database is kept up to date on a remote server for ease of access wherever internet is available. The database may be periodically downloaded to a Smartphone Application or other software program for use when data connection is available, for offline use.

The registration information may be provided using a mobile application on a mobile computing device or may use a web-based registration form to provide the IFF system 15 with registration information. The registration information may include identification information for the drone 1 (e.g., manufacturer, model, manufacture date, etc.) and identification information for the beacon 2 (e.g., identification number or identification card). The registration information may also include identification information for the drone owner/pilot 10 (e.g., name, address, phone number, email address, etc.). The registration process is discussed in greater detail below with respect to the user interfaces of FIG. 10.

The backend of the IFF system 15 may facilitate communication using wired or wireless signals such as a Wi-Fi, cellular, satellite communication, ZigBee, Bluetooth, a direct line-of-sight laser signal, or any other type of wireless signal that may be apparent to a person of ordinary skill in the art.

As illustrated in FIG. 6, the operator/observer 5 may use a handheld IFF interface unit 4 to wirelessly communicate with the beacon 2 at 605. In some example implementations the IFF interface unit 4 may be an IFF specific mobile device designed to interact with the IFF system and registered secure beacons such as the beacon 2. In other example implementations, the IFF interface unit 4 may be the operator/observer's 5 personal communications device (e.g. smart phone, tablet, smart watch etc.) running a software program or mobile application designed to interface with the IFF system 15.

The IFF Smartphone App or software program may be compatible with all latest generation smartphones, either natively or through a web application. Using the onboard RF antenna, the app may receive transmissions (e.g., Wi-Fi, cellular, satellite communication, ZigBee, Bluetooth, or any other wireless frequency or protocol that might be apparent to a person of ordinary skill in the art) from the IFF Beacon which it cross-references with an IFF Database. The App may then display an augmented reality user interface incorporating any publicly available drone and pilot information associated with the IFF Beacon over the smartphone camera view as discussed below. Through the app the user may access any relevant/available pilot and sUAS data contained in the database (or transmitted directly from the beacon) as well as the ability to contact the pilot anonymously if so desired.

In some example implementations, the IFF interface unit 4 may also include an IFF receiver. The IFF Receiver may be a compact handheld device capable of extending the effective range of the IFF Smartphone App running on a mobile device. The receiver may be comprised of a housing, battery, microcontroller with support electronics, Bluetooth receiver, and single directional antenna (e.g., Wi-Fi, cellular, satellite communication, ZigBee, Bluetooth, or any other wireless frequency or protocol that might be apparent to a person of ordinary skill in the art) (and potentially a high powered camera). The receiver may pair with a mobile device (e.g., a large-screen, latest generation smartphone or mini tablet) and provides an ergonomic platform for aiming and operating the smartphone app.

With the IFF interface unit 4, the operator/observer 5 may receive an encrypted code or identification number from the beacon 2 mounted on the drone 1 via wireless communication signal 610. In some example implementations, signal 610 may also include pilot specified information (e.g., drone type, company, mission, social media feed, contact information or any other information that might be apparent to a person of ordinary skill in the art).

Once the operator/observer 5 receives the encrypted code or identification number from the beacon 2, the operator/observer 5 may provide the encrypted code or identification number to the IFF system 15 using wireless communication signals 615 along with a request for identification of the drone 1 and/or contact information of the drone owner/pilot 10. Any kind of encryption/authentication scheme may be used to establish a trusted communications link between devices. Please reference the Mind Tribe document “Security Overview” that was previously shared for more information on this matter.

In some example implementations, the X509-type certificates may be used to create a chain of trust that enables the Beacon and Reader to challenge and verify each other without requiring any pre-shared information beyond a single trusted root certificate.

For example, a drone owner/pilot may use a specialized provisioning tool to generate a provisioning certificate (with an expiration date) that will be signed by a trusted root certificate. Getting the root certificate signature may be the only step that requires network access - the rest of the process can be done offline.

Prior to a flight, the beacon 2 may generates its own certificate (also with an expiration date), which is signed by the provisioning certificate. The provisioning certificate and individual beacon certificate may be transmitted to the Reader 4 to confirm trust.

The Reader 4 side may follow the same process - a provisioning certificate is signed by the root certificate (requiring network access), which is then used to sign the Reader's certificate offline.

The Reader 4 may stores both the Reader's certificate and the provisioning certificate that signed it and transmits them to the beacon 2 to confirm trust. In order to determine that a drone is friendly, the Reader 2 will broadcast a challenge message containing:

1. Current timestamp.

2. Reader's certificate.

3. Reader's provisioning certificate.

4. Signature of message using Reader's certificate.

The beacon will receive this challenge, and verify that:

1. The current timestamp is within the allowable clock skew. 2. The Reader's certificate was signed by the Reader's provisioning certificate and is valid.

3. The Reader's provisioning certificate was signed by the trusted root certificate and is valid.

4. The message signature is correct, which proves that the sender of this message is the Reader 4 since only the Reader 4 will have access to the Reader's private key needed to generate the signature.

Once all of these have been verified, the Beacon will respond with a message that is encrypted using the Reader's public key, which contains:

1. The same timestamp from the first message.

2. Beacon's certificate.

3. Beacon's provisioning certificate.

4. Signature of message using Beacon's certificate.

The Reader 4 will decrypt this message and perform the same verification steps as the beacon 2. Once the beacon 2 is verified, the Reader 4 can indicate to the operator/observer 5 that there is a friendly beacon 2 in the area.

In some example implementations, if the operator/observer 5 would like to confirm the drone they see is the one the reader has identified as a friend the Reader 4 may command the beacon 2 to blink by sending a message encrypted with the beacon's private key containing the blink pattern in addition to the four components of the challenge message.

The IFF system 15 may reply to the wireless communication signal 615 with identification information associated with the drone and/or pilot/owner 10 transmitted through wireless communication signal 620. In some example implementations, the identification information may include identification information which may identify and/or allow communications with the drone owner/pilot 10. For example, the identification information may include the drone owner/pilot's 10 name, phone number, email address, social media username, or any other information that may be used to identify and/or contact the drone owner/pilot 10.

After receiving the identification information by the wireless communication signal 620, the operator/observer 5 may send a communication signal 625 to the IFF system 15 requesting verification that the registered drone owner/pilot 10 is actually controlling the drone 1 without directly contacting the drone owner/pilot 10. In response, the IFF system 15 provides a two-stage verification process. Specifically, the IFF system 15 may send a verification request communication signal 630 to a communication platform 18 (e.g., an instant messaging platform, a VOIP platform, or any other type of communication platform that might be apparent to a person of ordinary skill in the art). In some example implementations, the verification request communication signal 630 may include a link to a verification website 17 located on a server of the IFF system 15. In parallel, the IFF system 15 may also initialize the verification website 17 by sending a communication signal 632 to prepare the verification website 17 to receive verification information from the drone owner/pilot 10.

After receiving the verification request communication signal 630, the communications platform may generate a message 635 (e.g., an Email, Instant message, SMS message, in-app message, etc.) with the link to the verification website 17 requesting that drone owner/pilot 10 provide a current location of the drone 1 and a PIN, password, or other validation code information associated with the drone 1 to the verification website 17.

The patent owner/pilot 10 would then be required to send a reply signal 640 to the verification site 17 in order to validate the drone owner/pilot 5 as the registered drone owner/pilot and verifying the current location of the drone. In some example implementations, the reply signal 640 may include a required/requested PIN, password or other validation code that may verify that the replying party is the registered owner/pilot. This may provide a second factor of authentication to allow confirmation that not only is the specific drone 1 authorized to be in a specific location, but that it is being piloted or flown by the registered owner/pilot and has not been commandeered by a rogue pilot who is impersonating the authorized pilot/owner. In other words, the owner/pilot is verified not only by being reachable using the registered contact information but also by providing the PIN, password, or validation code associated with the drone 1.

The verification website 17 may provide the received information from the reply signal 640 to the IFF system 15 through communication signal 645 and the IFF system 15 will compare the received information to the information stored in the IFF database to determine whether the drone owner/pilot 10 has verified the drone's location and passed the verification test provided by the verification site.

The IFF system 15 may then send a signal to the 650 operator/observer 5 providing the results of the verification/validation process. If the operator/observer 5 is satisfied that the drone 1 associated with the beacon 2 is authorized and operated in accordance with applicable flight restrictions/access guidelines, the inquiry of the operator/observer 5 may be completed. The observer/operator 5 and the drone owner/pilot 10 may go about their respective activities. Alternatively, if the operator/observer 5 is not satisfied that the drone 1 associated with the beacon 2 or is not operated in accordance with applicable flight restrictions/access guidelines, the operator/observer 5 may take responsive action by initiating or requesting interdiction (e.g. soft interdiction or hard interdiction) of the drone 1. Example implementations of this interdiction may be discussed in greater detail below.

In FIG. 6, the observer/operator 5 also has the ability to send a report or update 655 to the IFF system 15. For example, the observer/operator 5 may report that the drone 1 was flying dangerously, hovering in intrusive locations or otherwise violating flight/access standards. The report or update 535 may also include an indication that the drone 1 has been commandeered or been stolen. The IFF system 15 may store the report or forward to another party to act upon.

In the example implementations of FIGS. 1-5, the observer/operator 5 may interface directly with the drone owner/pilot 10 through communications 125/525/530. However, in certain situations either the observer/operator 5 and/or drone owner/pilot 10 may wish to not directly interface with the other. This may be a safety concern, a privacy concern, or merely a personal preference. The following embodiments may allow the IFF system 15 or some other third party system to provide a barrier.

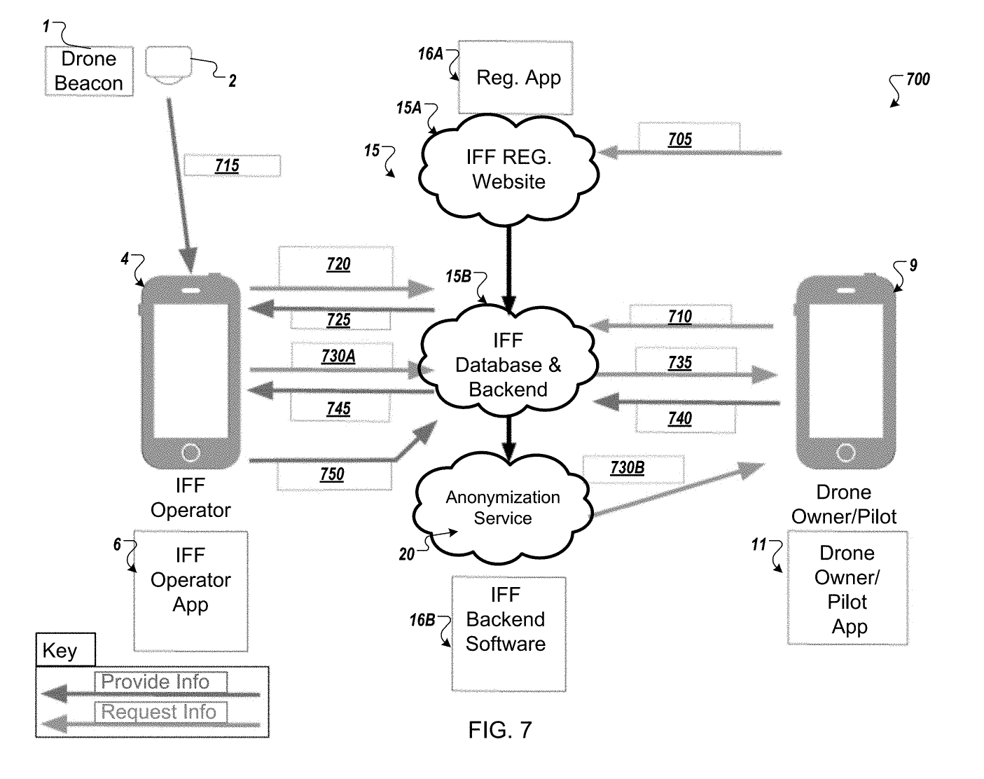

FIG. 7 illustrates a schematic representation 700 of a system in accordance with another example implementation of the present application. Some aspects of the schematic representation 700 may be similar to aspects of the schematic representations 100, 500 and 600 of FIGS. 1-6. Thus, similar description and reference numerals may be provided. In FIG. 7, the schematic representation 700 illustrates the interaction of hardware devices associated with the operator/observer 5, the IFF system 15, and the drone owner/pilot 10. Specifically, an operator/observer associated device 4 and a pilot/owner associated device 9 may be illustrated interacting with the IFF system 15 in the example implementation of FIG. 7.

Though FIG. 7 may illustrate the hardware devices associated with operator/observer 5, the IFF system 15, and the drone owner/pilot 10 as smart phones or tablets, example implementations of the present application are not limited to smart phone or tablets and may be any device capable of performing the described functions as may be apparent to a person of ordinary skill in the art.

In the illustrated implementation, the drone 1 may be operated by an owner or pilot 10 in a location (e.g., a public location, a private location, a secured location or any other type of location that might be apparent to a person of ordinary skill in the art). Further, the drone 1 again may include an identification beacon 2 that may be either integrated into the drone itself by the drone manufacturer or added as an aftermarket module by the owner/pilot 10. The beacon 2 may be a small, self-contained wireless transmitting device that is registered with a database that is part of the IFF system 15. For example, the beacon 15 may broadcast an encrypted signature using SSL certificates that are unique to each beacon that enables the rest of the IFF System 15 to identify the drone and verify whether it is permitted to fly in any given airspace.

Other methods of establishing an authenticated or trusted communication may be used. For example, the challenge/reply scheme discussed above may be used. Alternatively, each Beacon and Reader with their own permanent IDs and secret keys, then pre-sharing all ID-key pairs with all Beacons and Readers so that they use the secret keys to verify each other.

Further in some example implementations, and to potentially speed up visual indication of multiple friendly drones as quickly as possible, a shared session key can be securely shared by the Reader with each Beacon as an additional (third) message in the initial challenge/response sequence. By encrypting the blink sequence using this pre-shared session key the same message can be sent to all friendly drones simultaneously while maintaining security.

Additionally, in some example implementations, the Reader may add a whitelist of all known friendly Beacons to its challenge messages. Readers who see their ID in the whitelist do not need to reply to the challenge since the Reader already knows that the Beacon exists. The Reader can periodically drop Beacon IDs from the whitelist in order to check if that Beacon is still in the area.

As illustrated, the pilot/owner associated device 9 may be used to register the drone 1 with the IFF system 15 using communication 705. The pilot/owner associated device 9 may run/interact with a mobile registration application 16A or may use a website-based registration form 15A to provide the IFF system 15 with registration information. The registration information may include identification information for the drone 1 (e.g., manufacturer, model, manufacture date, etc.) and identification information for the beacon 2 (e.g., identification number or identification card). The registration information may also include identification information for the drone owner/pilot 10 (e.g., name, address, phone number, email address, etc.). The registration process is discussed in greater detail below with respect to the user interfaces of FIG. 10.

Either the mobile registration application 16A or the website-based registration form 15A may be used to perform one or more of:
Create owner/pilot profile;
Register beacons;
Enter drone serial numbers;
Upload photos of drone; and
Register phone numbers.

In some implementations, the owner/operator 10 may not pre-register the information using communication 705 but the identification information for the drone 1, the beacon 2, and the drone owner/pilot 10 may be provided to the IFF system 15 in real time using communication 705 while the drone owner/pilot 10 is operating the drone 1.

The IFF system 15 may include a database 15B to store received information and a backend to facilitate communications between the IFF system and other parties and provide information stored in the database to authorized requesters. The database 15B may be a proprietary database set-up for operation by corporate clients, a public database maintained by a third party, or a combination of both. The database 15B may contain confidential sUAS information such as unique identifiers, sUAS data, registered flight plans, airspace access permissions, purchased permits, social media connections, FAA registrations, sUAS owner (private or corporate), and pilot information. This database 15B is kept up to date on a remote server for ease of access wherever internet is available. The database 15B may be periodically downloaded to a Smartphone Application or other software program for use when data connection is available, for offline use. The IFF database and backend 15B may be running backend software 16B, which may perform one or more of:
Store Registration Information;
Serve drone/owner information;
Process contact requests;
Cross reference GPS locations between IFF receiver and drone owner;
Log complaints; and
Log activities.

As illustrated in FIG. 6, the operator/observer associated device 4 may be a handheld IFF interface unit that may wirelessly communicate with the beacon 2. In some example implementations, the operator/observer associated device 4 may be an IFF specific mobile device designed to interact with the IFF system 15 and registered secure beacons such as the beacon 2. In other example implementations, the IFF interface unit 4 may be the operator/observer's personal communications device (e.g. smart phone, tablet, smart watch etc.) running a software program or mobile application 6 designed to interface with the IFF system 15.

The software program or mobile application 6 may allow the operator/observer associated device 4 to do one or more of:
Read signals via Wi-Fi, cellular, satellite communication, ZigBee,
Bluetooth, or any other wireless frequency or protocol that might be apparent to a person of ordinary skill in the art;
Send Queries to the IFF Backend;
Display drone owner information;
Sends text to drone owner (via an anonymization service or dedicated app);
Call a drone owner; and
Log complaints.

In some example implementations, the operator/observer associated device 4 may also include an IFF receiver. The IFF Receiver may be a compact handheld device capable of extending the effective range of the Smartphone App 6 running on a mobile device. The receiver may be comprised of a housing, battery, microcontroller with support electronics, Bluetooth receiver, and single directional antenna (e.g., Wi-Fi, cellular, satellite communication, ZigBee, Bluetooth, or any other wireless frequency or protocol that might be apparent to a person of ordinary skill in the art) (and potentially a high powered camera). The receiver may pair with operator/observer associated device 4 (e.g., a large-screen, latest generation smartphone or mini tablet) and provides an ergonomic platform for aiming and operating the smartphone app or may be a separate, independent stand-alone device.

Similarly, the owner/pilot associated device 9 may be a handheld interface unit that may wirelessly communicate with the IFF system 15. In some example implementations, the owner/pilot associated device 9 may be a specific mobile device designed to interact with the IFF system 15. In other example implementations, the owner/pilot associated device 9 may be the owner/pilot's personal communications device (e.g. smart phone, tablet, smart watch etc.) running a software program or mobile application 11 designed to interface with the IFF system 15.

The software program or mobile application 11 may allow the drone owner/pilot associated device 9 to do one or more of:
Create owner/pilot profiles;
Register beacons/drones;
Enter Drone serial numbers;
Upload photo of the drone;
Register phone numbers;
Log flights & GPS locations;
Update profiles;
Upload photos to profiles.

During operation of the drone 1, the owner/pilot associated device 9 may regularly log location and other activities performed by the drone owner/pilot 10 during operation of the drone. The owner/pilot associated device 9 may report these logged activities to the IFF system 15 through communication signal 710. In some example implementations, the logged activity information sent with the communication signal 710 may also include GPS data associated with the drone 1.

Further, in some example implementations, the pilot may also load specific information onto the beacon 2 that would be available to the operator/observer associated device 4 if an internet device is not available. For example, the pilot/owner may load contact information (e.g., phone number, email, social media link, current mission, current access authorizations, or any other information that might be apparent to a person of ordinary skill in the art).

The operator/observer associated device 4 may receive an encrypted code or identification number from the beacon 2 mounted on the drone 1 via wireless communication signal 715. Once operator/observer associated device 4 receives the encrypted code or identification number from the beacon 2, the operator/observer associated device 4 may provide the encrypted code or identification number to the IFF system 15 using wireless communication signal 720 along with a request for identification of the drone 1 and/or contact information of the drone owner/pilot 10. In some example implementations, the wireless communication signal 720 may also include GPS or other location information associated with the operator/observer associated device 4.

The IFF system 15 may reply to the wireless communication signal 720 with identification information associated with the drone 1 and/or pilot/owner 10 transmitted through wireless communication signal 725. In some example implementations, the identification information may include identification information which may identify and/or allow communications with the drone owner/pilot 10. For example, the identification information may include the drone owner/pilot's 10 name, phone number, email address, social media username, or any other information that may be used to identify and/or contact the drone owner/pilot 10.

After receiving the identification information by the wireless communication signal 725, the operator/observer associated device 4 may send a communication signal 730A to the IFF system 15 requesting a message or phone call with the drone owner/pilot 10. In response, the IFF system 15 may route the message or phone call request to through an anonymization service 20 that strips out the operator/observer associated device's 4 identification information from the request to generate communication 730B and create an anonymized communication between the operator/observer associated device 4 and the owner/pilot associated device 9.

Further, the IFF database and backend 15B may compare the received activity log received at 710 with the received GPS data associated with communication signal 720 received from the operator/observer associated device 4. If the comparison indicates that drone 1 may not be authorized to be in a particular area, or may not be currently controlled by the registered owner/pilot, the IFF database and backend 15B may send an urgent alert signal 735 to the drone owner/pilot associated device 9.

The drone owner/pilot associated device 9 may then be required to send a reply signal 740 in order to validate the drone owner/pilot 5 as the registered drone owner/pilot and verifying the current location of the drone. In some example implementations, the reply signal 740 may include a required/requested PIN, password or other validation code that may verify that the replying party is the registered owner/pilot. This may provide a second factor of authentication to allow confirmation that not only is the specific drone 1 authorized to be in a specific location, but that it is being piloted or flown by the registered owner/pilot and has not been commandeered by a rogue pilot who is impersonating the authorized pilot/owner. In other words, the owner/pilot is verified not only by being reachable using the registered contact information but also by providing the PIN, password, or validation code associated with the drone 1.

The IFF database and backend 15B may provide the received information from the reply signal 740 to observer/operator associated device 4 through communication signal 745. If the operator/observer 5 is satisfied that the drone 1 associated with the beacon 2 is authorized and operated in accordance with applicable flight restrictions/access guidelines, the inquiry of the operator/observer 5 may be completed. The observer/operator 5 and the drone owner/pilot 10 may go about their respective activities. Alternatively, if the operator/observer 5 is not satisfied that the drone 1 associated with the beacon 2 or is not operated in accordance with applicable flight restrictions/access guidelines, the operator/observer 5 may take responsive action by initiating or requesting interdiction (e.g. soft interdiction or hard interdiction) of the drone 1 or reporting it to the authorities. Example implementations of this interdiction may be discussed in greater detail below.

In FIG. 7, the observer/operator associated device 4 may also have the ability to send a report or update 750 to the IFF system 15. For example, the observer/operator 5 may report that the drone 1 was flying dangerously, hovering in intrusive locations or otherwise violating flight/access standards. The report or update 750 may also include an indication that the drone 1 has been commandeered or been stolen. The IFF system 15 may store the report or forward to another party to act upon.

In the example implementations of FIGS. 1-7, the drone 1 may be detected/observed by a person or mobile device associated with a person. However, in some example implementations the drone may alternatively be detected by an automated base station or sensor tower.

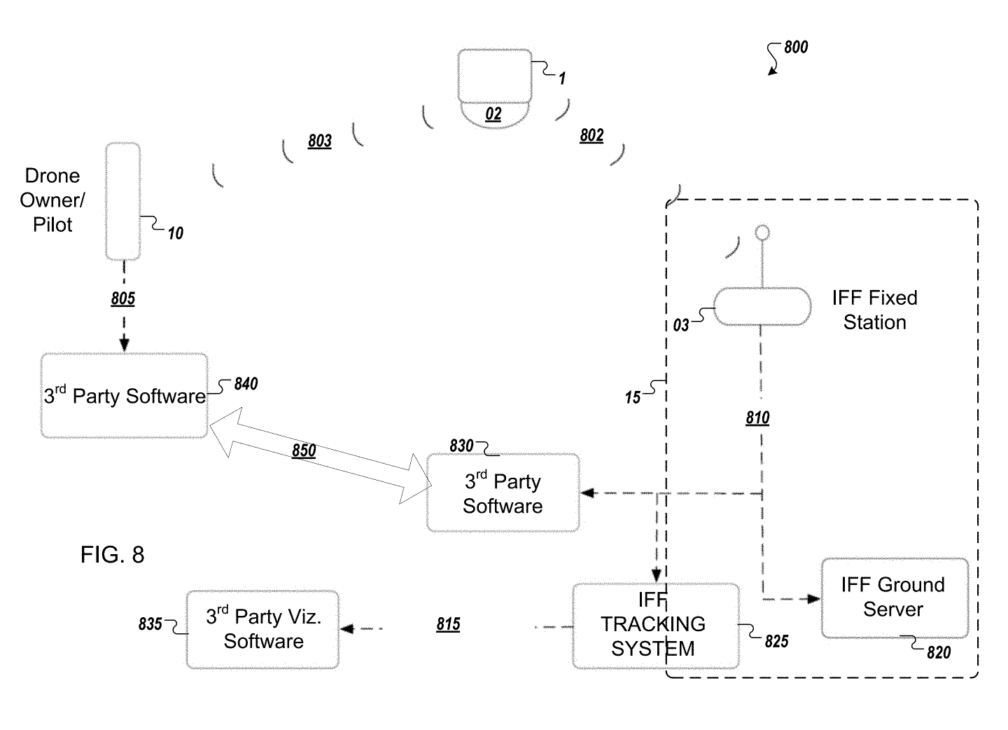

FIGS. 8 illustrate a schematic representation 800 of a system in accordance with another example implementation of the present application. Some aspects of the schematic representation 800 may be similar to aspects of the schematic representations 100, 500, 600 and 700 of FIGS. 1-6. Thus, similar description and reference numerals may be provided. In FIG. 8, the schematic representation 800 illustrates a fixed base station 3 that is integrated with the IFF system 15.

Again, a drone 1 may be operated by an owner or pilot 10 in a location (e.g., a public location, a private location, a secured location or any other type of location that might be apparent to a person of ordinary skill in the art).

Further, the drone 1 again may include an identification beacon 2 that may be either integrated into the drone itself by the drone manufacturer or added as an aftermarket module by the owner/pilot 10. The beacon 2 may be a small, self-contained wireless transmitting device that is registered with a database that is part of the IFF system 15. For example, the beacon 15 may broadcast an encrypted signature using SSL certificates that are unique to each beacon that enables the rest of the IFF System 15 to identify the drone and verify whether it is permitted to fly in any given airspace. The SSL certificate may be a Wi-Fi SSL or any RF communication frequency/protocol. Alternative processes used to establish a verified/secured session may be used as described above.

As illustrated in FIG. 8, the drone 1, communicates with a fixed base station 3 of the IFF system 15 wirelessly with communication signal 802. Communication signal 802 may include a unique identifier associated with the beacon 2, an encrypted security key, and GPS coordinates other location information associated with the drone 1. The fixed base station 3 and IFF ground server 820 may communicate with each other, an IFF tracking system 825 and a third-party software package 830 using communication signal 810. The communications signal 810 may provide the IFF ground server 820 with the identifier associated with the beacon and the received location information for storage and updating flight logs. The communication signal 810 may also provide the third-party software 830 with the received location information and identification information associated with the beacon 2 for verification of the logged information stored to the IFF ground server 820.

Further, the drone 1 may also communicate with the drone owner/pilot 10 via communication signal 803. Communication signal 803 may also include a unique identifier associated with the beacon 2, and encrypted security key, and GPS coordinates or other location information associated with the drone 1. The drone owner/pilots may communicate with the third-party software package 840 using communication signal 805, which includes the received unique identifier associated with the beacon 2, the encrypted security key, and the GPS coordinates associated with the drone 1.

The third-party software package 830 and the third-party software package 840 may be the same third-party software package or separate third-party software packages configured to communicate with each other over a communications network or other backend system. The third-party software package 830 and the third-party software package 840 may exchange information 850 in order to verify that the location information (e.g. GPS coordinates) associated with the drone received by the fixed base station 3 matches the location information (e.g., GPS coordinates) reported by drone owner/pilot 10 based on the received identifier information associated with the beacon 2. Based on the results of a comparison performed by the third-party software package 830 and the third party software package 840, the third-party software package 830 may report back to the IFF ground server 820 that the received GPS coordinates or other location information have been verified.

The IFF tracking system 825 may also communicate with third-party visualization software 835 to generate a graphical representation of the drone 1 overlaid onto a map, aerial photo, satellite photo, or other representation of a location within which the drone reference 1 has been detected. In others words, example implementations consistent with FIG. 8 may provide not only verification of the location and/or identity of the drone 1, but may also produce a real time visualization, or a historical visualization of the drone 1 location, similar to radar tracking or other flight management systems used for large fixed wing aircraft.

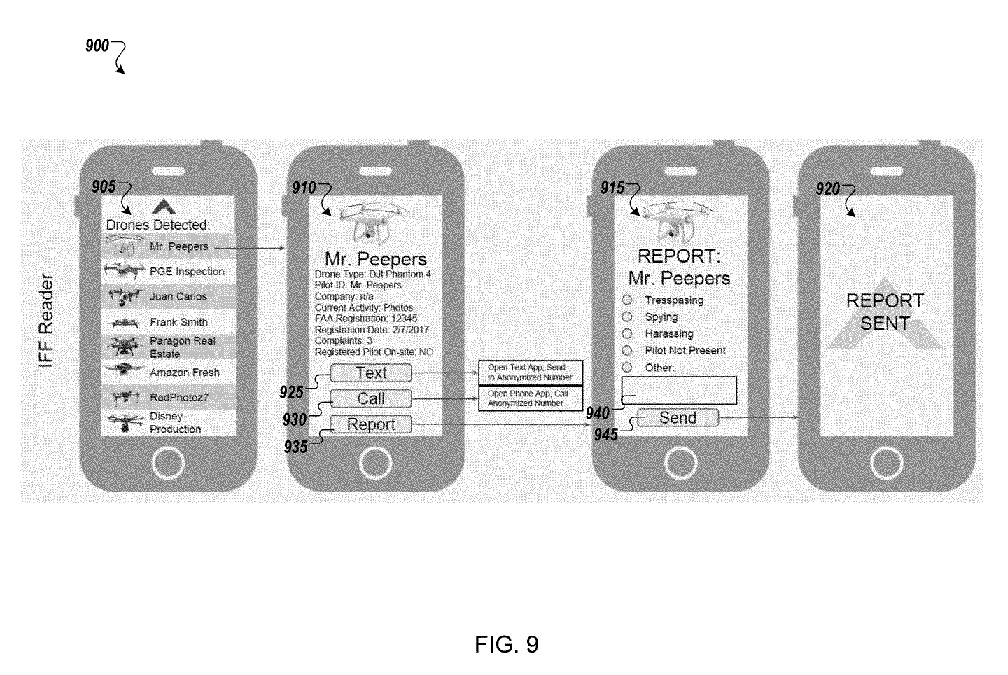

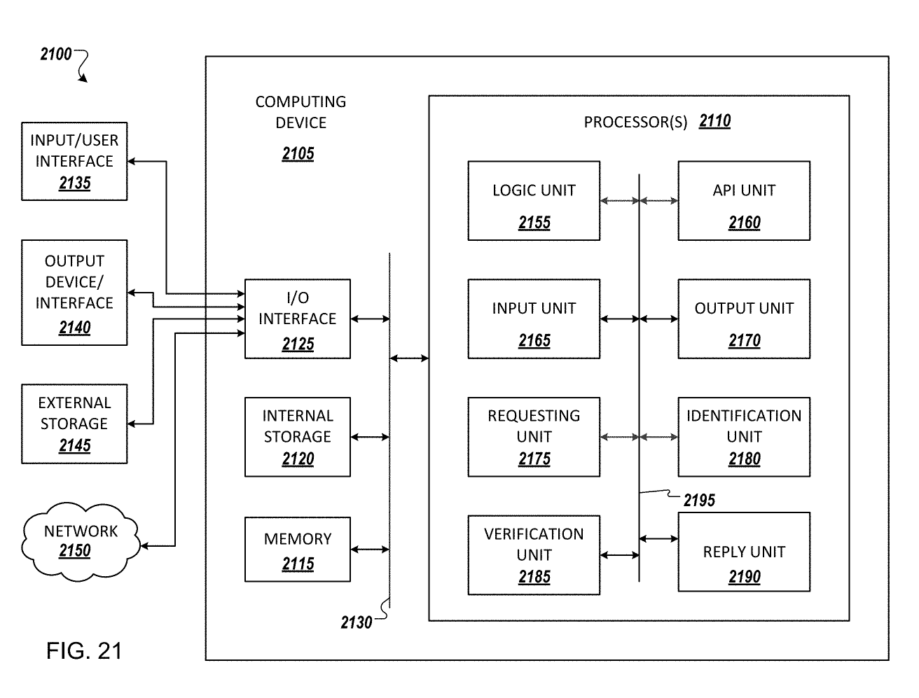

FIGS. 9-12 illustrate user interfaces (UI) 900-1200 that may be used as part of the electronic communication signals discussed above with respect to the example implementations illustrated in FIGS. 1-8. Each UI 900-1200 may be displayed on a display device such as a computer screen, laptop screen, touchscreen of a mobile computing device or other display device that may be apparent to a person of ordinary skill in the art. The UIs 900-1200 may be used to control a computing device such as computing device 2105 of the computing environment 2100 illustrated and discussed below with respect to FIG. 21. The functionalities illustrated in the UIs 900-1200 are example functionalities that may be implement using the illustrated or similar UIs. Other UIs or functionalities may be apparent to a person of ordinary skill.

As illustrated in FIG. 9, the UI 900 includes a plurality of screens 905-920 which may be navigated between by selecting various options on each screen. The UI 900 may be an example implementation of the UI that may be used to identify a drone detected in the vicinity of an observer/operator (e.g. observer/operator 5 illustrated in the above discussed embodiments). The UI 900 may also be used to contact the owner/pilot of a detected drone (e.g. drone owner/pilot 10 of the drone 1 discussed above) and/or log a report with an IFF system (e.g., IFF system 15).

Screen 905 may include a listing of all drones for which a beacon has been detected within the sensor range. By selecting one of the listed drones, screen 905 may transition to screen 910 which provides information regarding the detected drone selected. The information provided may be received from a database associated with an IFF system based on a unique identifier received from a beacon attached to the drone or broadcast directly from the beacon.

The screen 910 may also provide a plurality of buttons 925, 930, 935 to perform various operations. For example, button 925 may be used to send a text to the registered owner/pilot associated with the detected drone selected. By selecting button 925, the UI 900 may transition to an integrated or independent texting application that may be used to send a text message or other short message to the registered number associated with the detected drone that was selected. In some example implementations, the registered number may be anonymized so that it is not accessible to a user using the UI 900.

Similarly, button 930 may be used to initiate a phone call, video call, or other real time communication with the registered owner/pilot associated with the detected drone that was selected to again, selecting the button 930 may transition to an integrated or independent real-time communications application that may be used to conduct the phone call, video call, or other real-time communication. In some example implementations, the registered phone number or other unique identifier used to initiate the phone call, video call, or other real-time communication may be anonymized so that it is not accessible to a user using the UI 900 or to the owner/pilot that received the communication.

Further, button 935 may be used to transition the UI 900 to screen 915 that may be used to launch or file a report regarding the detected drone that was selected. As illustrated, the screen 915 may provide options for submitting various types of reports (e.g., “trespassing”, “spying”, “harassing”, “pilot not present”, or any other commonly occurring type of report that might be apparent to a person of ordinary skill in the art). In some example implementations, the screen 915 may also include an option to select “other” and/or a text entry field 940 that may be used to draft a report for which there is not an existing type or option.

The screen 915 may also include a button 945 that is used to submit the report once it has been prepared. By selecting the button 945, the UI 900 may transition to screen 920 providing verification that the report has been sent. Once the report has been sent, the UI 900 may transition back to any one of screens 905 or 910.

As illustrated in FIG. 10, the UI 1000 includes a plurality of screens 1005-1020 which may be navigated between by selecting various options on each screen. The UI 1000 may be an example implementation of the UI that may be used to register a drone (e.g. drone 1 discussed in example implementations above) and an owner/pilot associated with the drone (e.g., drone owner/pilot 10 discussed in example implementations above) with an IFF system (e.g. IFF system reference 15 discussed above).

Screen 1005 may provide an account creation operation by allowing a user of the UI 1000 to enter his or her name and other identification information in a series of text entry fields represented within the broken line box 1025. Further screen 1005 may also provide a creation button 1030 that may be selected to create an account and transition the UI 1000 to screen 1010.

Screen 1010 may provide a drone registration operation by allowing the user of the UI 1000 to provide identification information associated with the drone. For example, control features illustrated within broken line box 1035 may be used to enter or select the manufacturer and model of the drone as well as enter a serial number associated with the drone and either select a stock image or upload a custom image of the drone. Further, screen 1010 may also provide a button 1040 that may be selected to register the drone and transition the UI 1000 to screen 1015.

Screen 1015 may provide a beacon registration/activation operation by allowing the user of the UI 1000 to provide identification information associated with a beacon mounted on the drone. For example, control features illustrated within broken line box 1045 may be used to enter a beacon identification number or provide an FAA registration number. Further, screen 1015 may also provide a button 1050 that may be selected to activate the beacon and transition the UI 1000 to screen 1020.

Screen 1020 may provide verification that the beacon has been activated. Once the beacon has been activated, the UI 1000 may transition back to screen 1005.

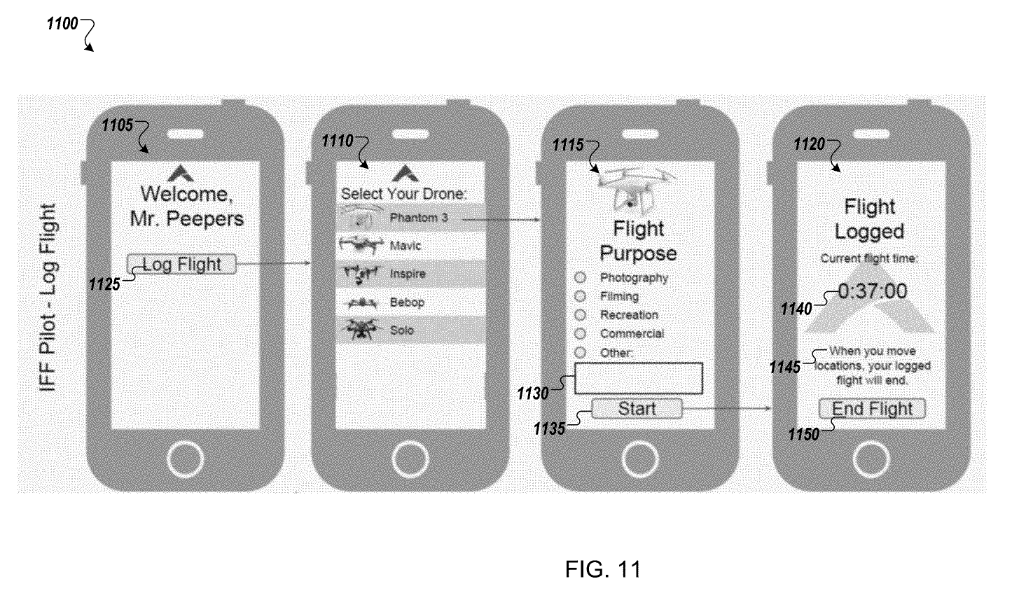

As illustrated in FIG. 11, the UI 11000 includes a plurality of screens 1105-1120 which may be navigated between by selecting various options on each screen. The UI 1100 may be an example implementation of the UI that may be used by an owner/pilot associated with a drone (e.g., drone owner/pilot 10 discussed in example implementations above) to log a flight with an IFF system (e.g. IFF system reference 15 discussed above) or directly on the beacon 2 (e.g., in a situation where a network connection to the IFF system is not available).

Screen 1105 may provide welcome screen with a button 1125 that may be used to start logging of the flight with the IFF system. When the button 1125 is selected, the UI 1100 may transition to screen 1110.

Screen 1110 may include a listing of all drones that have been registered IFF system as being previously registered by the user (e.g., an owner/operator) of the UI 1100, who may be the registered owner/operator. By selecting one of the listed drones, screen 1110 may transition to screen 1115 which may be used to provide information regarding the flight to be locked using the UI 1100.

As illustrated, screen 1115 may provide options for selecting various types of flights to be logged (e.g., “a photography flight”, “a filming flight”, “a recreational flight”, “a commercial flight”, or any other type of flight purpose that may be apparent to a person of ordinary skill in the art). In some example implementations, the screen 1115 may also include an option to select “other” and/or a text entry field 1130 that may be used to define a different flight purpose to be logged which is not one of the existing available options. The screen 1115 may also include a buttoned 1135 that may be used to start the logging once the flight type or flight purpose has been defined. By selecting the button 1135, the UI 1100 may transition to screen 1120.

Screen 1120 may provide an indicator 1140 providing a real-time indication of flight time since the button 1135 was pressed and logging of the flight was started. Further, in some example implementations a warning 1145 may be provided that if the device on which UI 1100 is displayed moves to a new location, the current flight log will end and a new flight log will be started. Still further, screen 1120 may also include a button 1150 that may be used to end logging of the current flight. Selection of button 1150 may cause the UI 1100 to transition back to screen 1105.

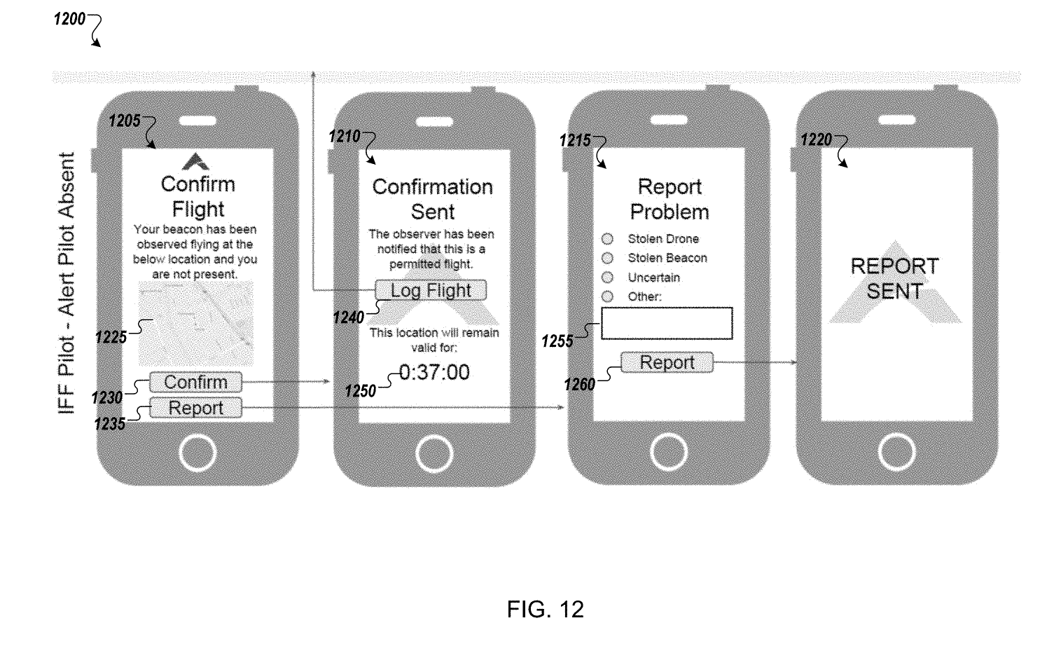

As illustrated in FIG. 12, the UI 12000 includes a plurality of screens 1205-1220 which may be navigated between by selecting various options on each screen. The UI 1200 may be an example implementation of the UI that may be used to request an owner/pilot associated with a drone (e.g., drone owner/pilot 10 discussed in example implementations above) confirm he or she is currently controlling his or her drone.

Screen 1205 may provide the initial flight confirmation request by providing an indicator or map 1225 indicating the current detected location of the beacon associated with a drone that the owner/pilot associated with the UI 1200. Screen 1205 may also provide a pair of buttons 1230, 1235 that may be used to either confirm actual control of the detected drone or report a problem. Specifically, button 1230 may be used to confirm actual control or operation of the detected drone and cause the UI 1200 to transition to screen 1210. Conversely, button 1235 may be used to report a problem and cause the UI 1200 to transition to screen 1215.

Screen 1210, which may be used to confirm actual control or operation of the detected drone, may provide a button 1240 that may be used to log the current flight of the drone. Selection of the button 1240 may cause the UI 1200 to transition to screen 1105 of UI 1100 discussed above. Further, screen 1210 may also include an indicator 1250 informing a user of the UI 1200 of a timeframe or future time for which the current confirmation or validation will be good (e.g., “This location will remain valid for: 0:37:00”) in some example implementations.

Screen 1215, which may be used to report a problem, may provide options for identifying various types of problems (e.g., “stolen drone”, “stolen beacon”, “uncertain”), or any other type of problem that may be apparent to a person of ordinary skill in the art. Further, in some example implementations, the screen 1215 may also include an option to select “other” and/or a text entry field 1255 that may be used to enter a textual description of a problem for which there is not an existing type or option.

The screen 1215 may also include a button 1260 that is used to submit the problem report once it has been prepared. By selecting the button 1260, the UI 1200 may transition to screen 1220 providing verification that the report has been sent. Once the report has been sent, the UI 1200 may transition back to screen 1205.

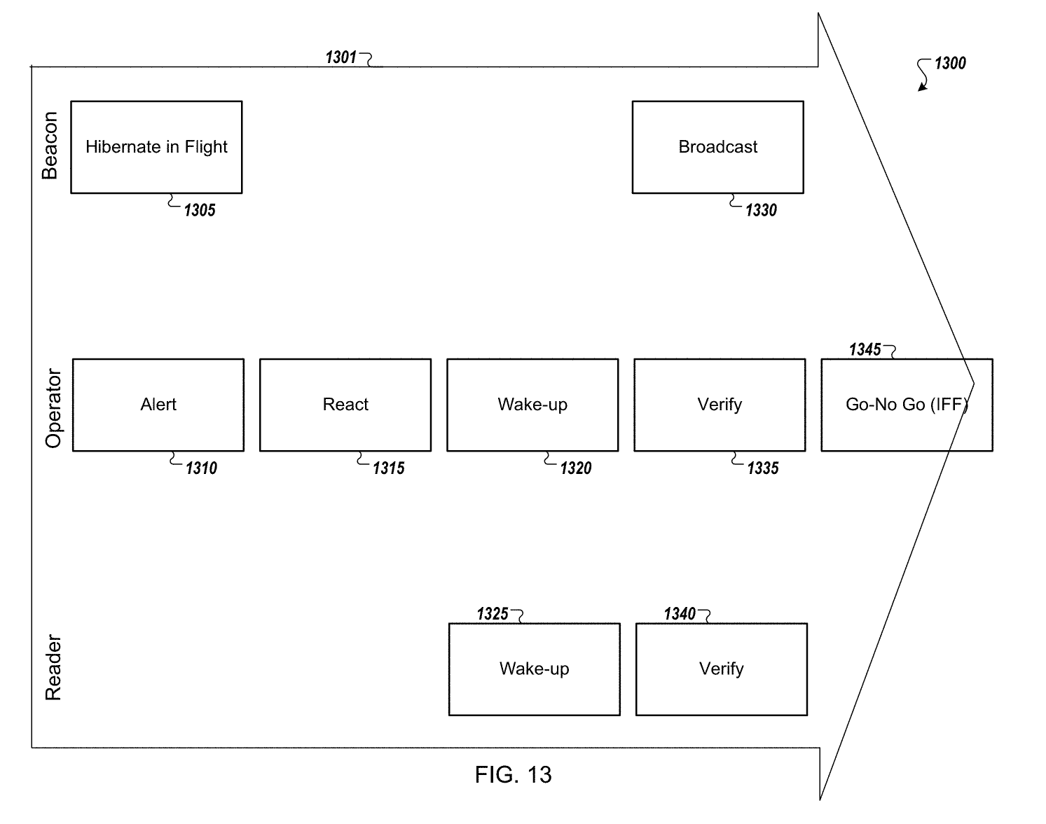

FIG. 13 illustrates the process 1300 of identifying an inbound drone or other aerial platform is either a friend or a foe (IFF) using a system in accordance with an example implementation of the present application. As illustrated, the process 1300 involves a series of steps performed by three parties: 1. an operator/observer (e.g. operator/observer 5 discussed above), 2. a beacon mounted on the drone or other aerial platform, and 3. a reader associated with an IFF system (e.g., an IFF interface device 4 illustrated in FIGS. 1-7 discussed above). In FIG. 13, arrow 1301 illustrates the direction of process flow performed by each of the three parties during the process 1300. In some example implementations, the reader associated with the IFF system may be an omnidirectional reader, or may be a directional reader which must be pointed at the drone.

As illustrated, at 1305 the beacon is in a hibernate-in-flight state, meaning that the beacon is in a hibernate mode listening for a wake-up command received via a communication signal. In parallel at 1310 the operator becomes alerted or aware that the drone is overhead, nearby, or incoming. This alert may be received by visually seeing the drone, hearing the drone, receiving some sort of warning, sensing the drone with a sensor (such as radar, for example), or any other process of receiving an alert that may be apparent to a person of ordinary skill in the art.

In response to the alert, the operator may react at 1315 by, for example, sheltering in place, or attempting to locate the UAV visually. In other words, the operator, uncertain of whether the drone is a friend or a foe, may hurriedly scan the sky in an attempt to locate the UAV. Simultaneously, the operator may grab the reader. At 1320, the operator may trigger a wake-up operation of the reader and wait to receive a reading from the reader.

At 1325 when the wake-up of the reader is triggered, it may transmit an encrypted signal requesting that any beacon within range prove that the drone on which it is mounted is a friend. In response to receiving the encrypted signal from the reader, the beacon may wake up, transmit a unique ID or other user specified information via a wireless signal before returning to a hibernation state at 1330.

At 1340, the reader may receive the unique ID broadcast by the beacon at 1330 and compare it to a database of known friendly drones and communicate to the operator identification information associated with the drone that has been identified as friendly. Additionally, information regarding an owner/pilot associated with the drone may also be provided by the reader to the operator. At 1335, the operator may receive the information provided by the reader and request, via the reader the drone provide a confirmation signal via a visual means (e.g., the operator may request the drone provide confirmation via a specific LED pattern which the drone will then provide in response). Finally, equipped with the knowledge of whether the drone is a friend or foe, the operator may take appropriate action at 1345. For example, the operator may decide to tolerate or allow the drone to continue its flight path (“Friend”), may avoid the drone (“unknown/soft foe”), or institute countermeasures to relocate, disable, or destroy the drone.

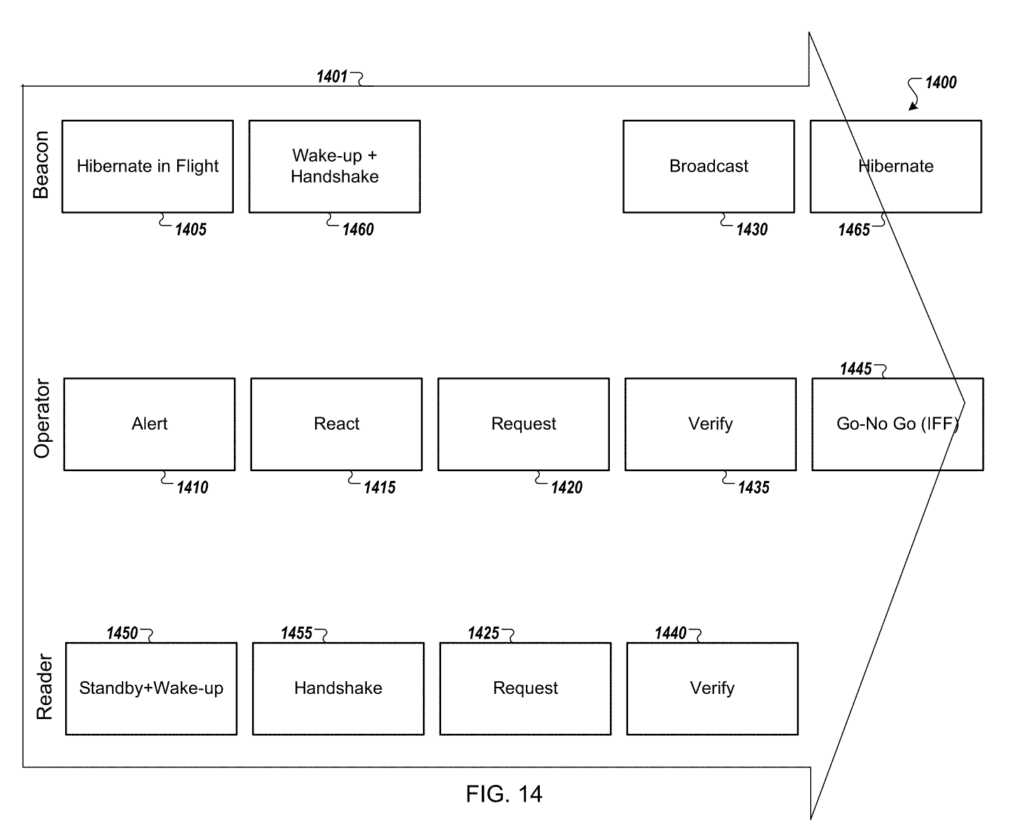

FIG. 14 illustrates another process 1400 of identifying if an inbound drone or other aerial platform is either a friend or a foe (IFF) using a system in accordance with an example implementation of the present application. As illustrated, the process 1400 involves a series of steps performed by three parties: 1. an operator/observer (e.g. operator/observer 5 discussed above), 2. a beacon mounted on the drone or other aerial platform, and 3. a reader associated with an IFF system (e.g., an IFF interface device 4 illustrated in FIGS. 1-7 discussed above). In FIG. 14, arrow 1401 illustrates the direction of process flow performed by each of the three parties during the process 1400. In some example implementations, the reader associated with the IFF system may be an omnidirectional reader, or may be a directional reader which must be pointed at the drone.

As illustrated, at 1405 the beacon is in a hibernate-in-flight state, meaning that the beacon is in a hibernate mode listening for a wake-up command received via a communication signal. In parallel, at 1410, the operator becomes alerted or aware that the drone is overhead, nearby, or incoming. This alert may be received by visually seeing the drone, hearing the drone, receiving some sort of warning, sensing the drone with a sensor (such as radar, for example), or any other process of receiving an alert that may be apparent to a person of ordinary skill in the art. Further, at 1450 the reader may periodically transition from a standby state to a wake-up state, issue an ID request command, and listen for a reply.

In response to the ID request command from the reader, the beacon may verify that the ID request command is legitimate using an onboard database of accepted wake-up codes, and reply by establishing a secure wireless connection with the reader, followed by transmitting the beacon's own unique identification code at 1460. The reader may receive the transmitted unique identification code from the beacon, compared to an onboard database of known friendly drones, and validate the beacon and trigger a “friendly drone detected” notification.

In response to the alert 1410, the operator may react at 1415 by, for example, sheltering in place, or attempting to locate the UAV visually. In other words, the operator, uncertain of whether the drone is a friend or a foe, may hurriedly scan the sky in an attempt to locate the UAV. Simultaneously, the operator may grab the reader and check if a “friendly drone detected” notification has been triggered. At 1420, the operator, having determined that the reader has detected and verified a nearby friendly drone, may request, via the reader, that the drone provide a confirmation signal via a visual means so that the operator can differentiate the friendly drone from other drones that might be in the vicinity. Simultaneously, the operator may target the drone with an optical scope.

At 1425, the reader may then transmit an encrypted signal requesting that the beacon prove that the drone on which it is mounted is friendly by flashing an onboard visual or Infrared (IR) light source (e.g., an LED) in an encoded, machine-readable pattern. In response to the encrypted signal, the beacon on the drone may transmit the requested encoded machine-readable pattern using an onboard visual or IR light source (e.g., an LED) at 1430.

At 1440, the reader may receive via the optical scope the encoded light pattern, decode it, and provide verification to the operator at 1435 that the UAV in view of the optical scope is friendly. This verification may be provided by a simple indicator light provided through the optical scope or through an augmented reality overlay through the optical scope.

At 1465, the beacon may return to the hibernate condition waiting for a subsequent identification command request. Finally, equipped with the knowledge of whether the drone is a friend or foe, the operator may take appropriate action at 1445. For example, the operator may decide to tolerate or allow the drone to continue its flight path (“Friend”), may avoid the drone (“unknown/soft foe”), or institute countermeasures to relocate, disable, or destroy the drone.

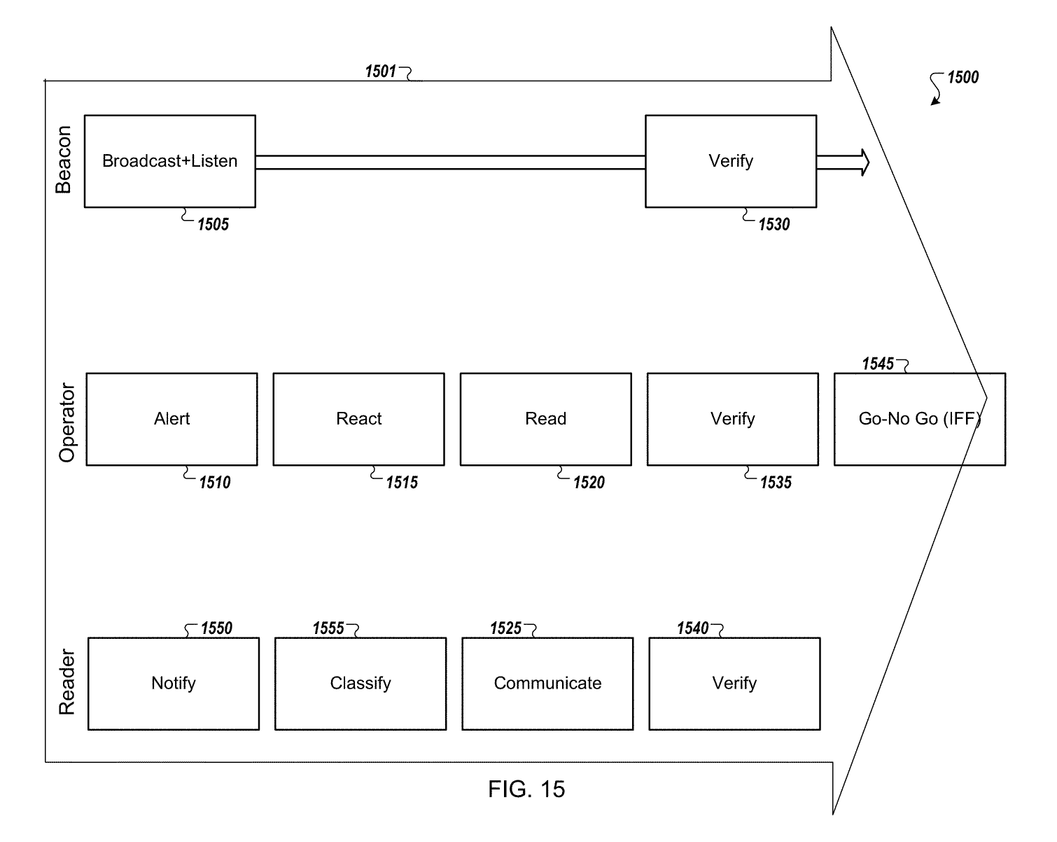

FIG. 15 illustrates another process 1500 of identifying if an inbound drone or other aerial platform is either a friend or a foe (IFF) using a system in accordance with an example implementation of the present application. As illustrated, the process 1500 involves a series of steps performed by three parties: 1. an operator/observer (e.g. operator/observer 5 discussed above), 2. a beacon mounted on the drone or other aerial platform, and 3. a reader associated with an IFF system (e.g., an IFF interface device 4 illustrated in FIGS. 1-7 discussed above). In FIG. 15, arrow 1501 illustrates the direction of process flow performed by each of the three parties during the process 1500. In some example implementations, the reader associated with the IFF system may be an omnidirectional reader, or may be a directional reader which must be pointed at the drone.

As illustrated, at 1505 the beacon continually broadcasts an encrypted signal containing its location and unique identifier and continuously listens for an LED flash command. In parallel, at 1510, the operator becomes alerted or aware that the drone is overhead, nearby, or incoming. This alert may be received by visually seeing the drone, hearing the drone, receiving some sort of warning, receiving the beacon broadcasts via the reader, sensing the drone with a sensor (such as radar, for example), or any other process of receiving an alert that may be apparent to a person of ordinary skill in the art. Further, at 1550, the reader continually listens for an encrypted signal being broadcast by a beacon, receives the broadcast signal from the beacon, and provides notification to the operator.

In response to the alert 1510, the operator may react at 1515 by, for example, sheltering in place, or attempting to locate the drone visually. In other words, the operator, uncertain of whether the drone is a friend or a foe, may hurriedly scan the sky in an attempt to locate the drone. Simultaneously, the operator may grab the reader and check if a notification has been triggered.

At 1555, the reader may compare the unique ID received from the beacon to an onboard database of known beacons. At 1525, the reader communicates the result of the comparison to the operator (e.g., “received code matches or is valid=friendly drone” or “received code does not match or is not valid=foe drone”). Additionally, information regarding the owner/pilot of the drone may be provided at 1525. Further, if the beacon provided GPS information, the location of the beacon may also be overlaid on a map associated with the reader's current location.

At 1520, the operator may review the communication provided by the reader and at 1535, the operator, having determined that the reader has detected and verified a nearby friendly drone, may request, via the reader, that the drone provide a confirmation signal via a visual means so that the operator can differentiate the friendly drone from other drones that might be in the vicinity. Simultaneously, the operator may target the drone with an optical scope.

At 1540, the reader may then transmit an encrypted signal requesting that the beacon prove that the drone on which it is mounted is friendly by flashing an onboard visual or Infrared (IR) LED in an encoded, machine-readable pattern. In response to the encrypted signal, the beacon on the drone may transmit the requested encoded machine-readable pattern using an onboard visual or IR LED at 1530.

Finally, equipped with the knowledge of whether the drone is a friend or foe, the operator may take appropriate action at 1545. For example, the operator may decide to tolerate or allow the drone to continue its flight path (“Friend”), may avoid the drone (“unknown/soft foe”), or institute countermeasures to relocate, disable, or destroy the drone.

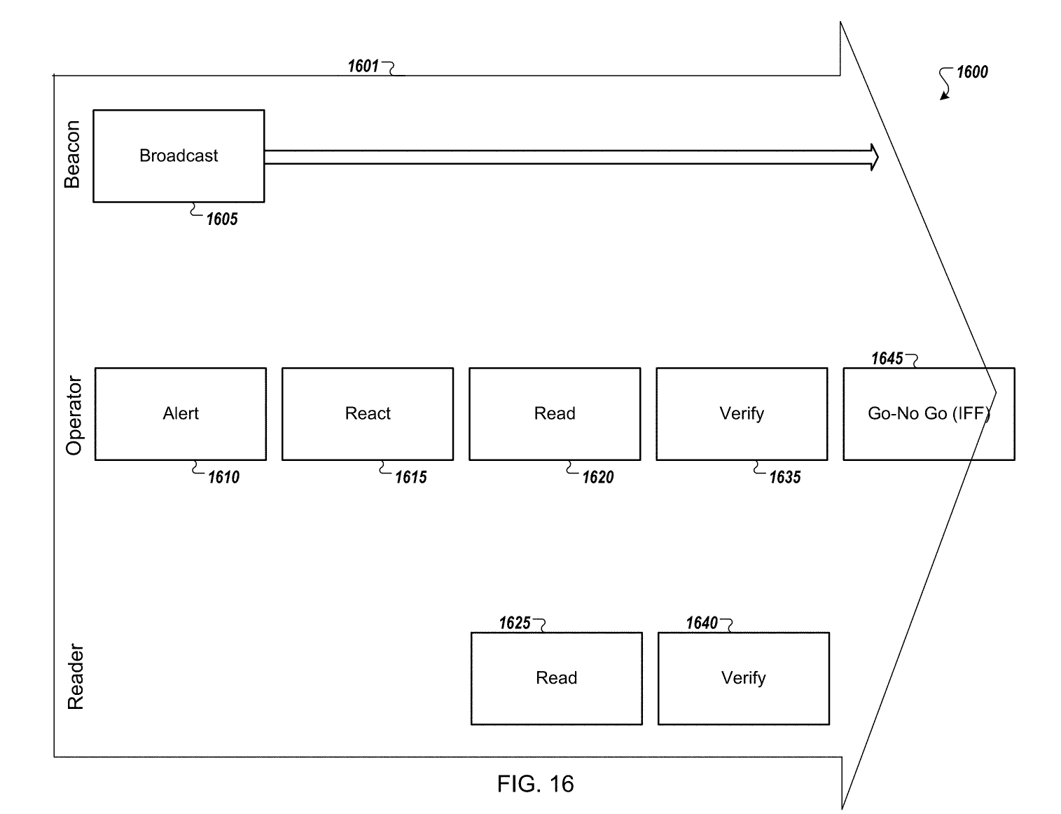

FIG. 16 illustrates another process 1600 of identifying if an inbound drone or other aerial platform is either a friend or a foe (IFF) using a system in accordance with an example implementation of the present application. As illustrated, the process 1600 involves a series of steps performed by three parties: 1. an operator/observer (e.g. operator/observer 5 discussed above), 2. a beacon mounted on the drone or other aerial platform, and 3. a reader associated with an IFF system (e.g., an IFF interface device 4 illustrated in FIGS. 1-7 discussed above). In FIG. 16, arrow 1601 illustrates the direction of process flow performed by each of the three parties during the process 1600. In some example implementations, the reader associated with the IFF system may be an omnidirectional reader, or may be a directional reader which must be pointed at the drone.

As illustrated, at 1605 the beacon continually broadcasts an encrypted signal containing its location and unique identifier. In parallel, at 1610, the operator becomes alerted or aware that the drone is overhead, nearby, or incoming. This alert may be received by visually seeing the drone, hearing the drone, receiving some sort of warning, receiving the beacon broadcasts via the reader, sensing the drone with a sensor (such as radar, for example), or any other process of receiving an alert that may be apparent to a person of ordinary skill in the art.

In response to the alert 1610, the operator may react at 1615 by, for example, sheltering in place, or attempting to locate the drone visually. In other words, the operator, uncertain of whether the drone is a cooperative or non-cooperative, may hurriedly scan the sky in an attempt to locate the drone. Further, at 1620, the operator may grab the reader, aim the reader at the drone in question, and wait for the reader to determine if an authorized code is being broadcast by the beacon.

At 1625, the reader may be powered on, listen for an identifier or secure code to be transmitted to the reader by the beacon. At 1640, the reader may compare the received identifier to an onboard database of known drones and communicate the result of the comparison to the operator (e.g., “received code matches or is valid=friendly drone” or “received code does not match or is not valid=non-cooperative drone”). Additionally, information regarding the owner/pilot of the drone may be provided at 1640. Further, if the beacon provided GPS information, the location of the beacon may also be overlaid on a map associated with the reader's current location. If no legitimate code is received, the reader may continue to search.

At 1635, the operator may receive and review the result of the comparison provided by the reader.

Finally, equipped with the knowledge of whether the drone is a friend or foe, the operator may take appropriate action at 1645. For example, the operator may decide to tolerate or allow the drone to continue its flight path (“Friend”), may contact authorities (e.g., Police, FAA, etc.) (“unknown/soft foe”), ground other aircraft in the area to prevent collisions, or institute countermeasures to relocate, disable, or destroy the drone.

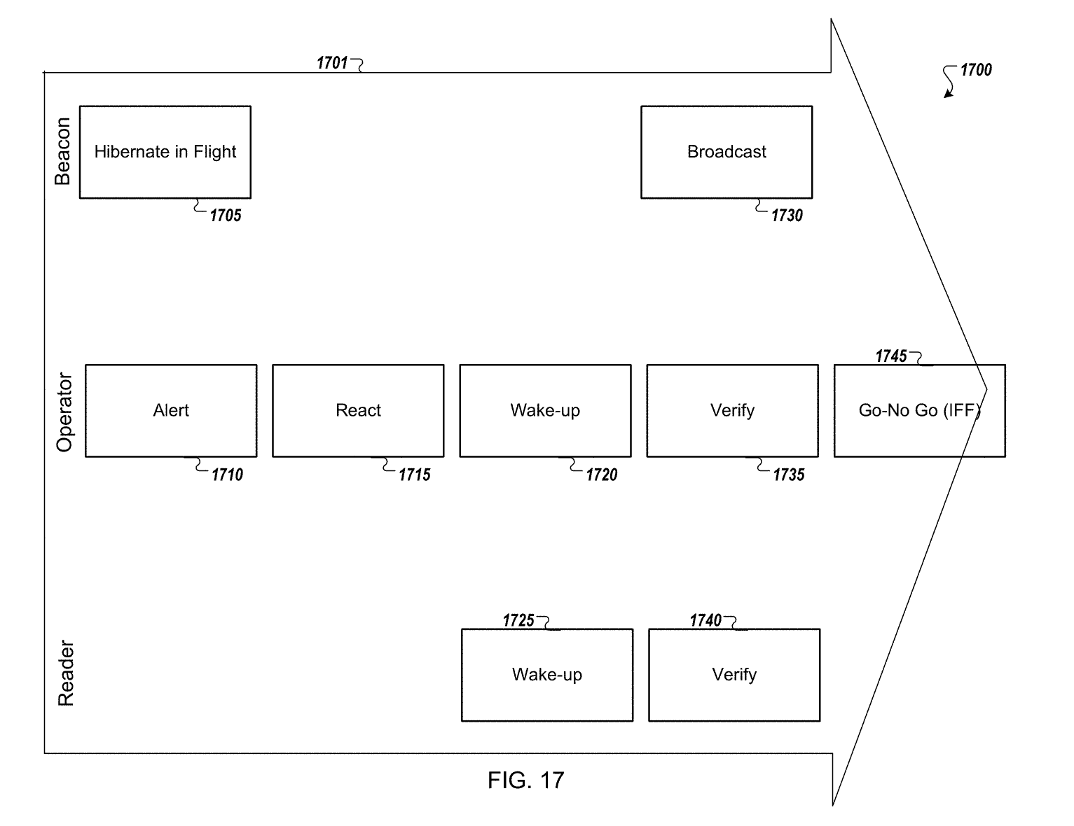

FIG. 17 illustrates another process 1700 of identifying if an inbound drone or other aerial platform is either a friend or a foe (IFF) using a system in accordance with an example implementation of the present application. As illustrated, the process 1700 involves a series of steps performed by three parties: 1. an operator/observer (e.g. operator/observer 5 discussed above), 2. a beacon mounted on the drone or other aerial platform, and 3. a reader associated with an IFF system (e.g., an IFF interface device 4 illustrated in FIGS. 1-7 discussed above). In FIG. 17, arrow 1701 illustrates the direction of process flow performed by each of the three parties during the process 1700. In some example implementations, the reader associated with the IFF system may be an omnidirectional reader, or may be a directional reader which must be pointed at the drone.

As illustrated, at 1705 the beacon is in a hibernate-in-flight state, meaning that the beacon is in a hibernate mode listening for a wake-up command received via a communication signal. In parallel at 1710 the operator becomes alerted or aware that the drone is overhead, nearby, or incoming. This alert may be received by visually seeing the drone, hearing the drone, receiving some sort of warning, sensing the drone with a sensor (such as radar, for example), or any other process of receiving an alert that may be apparent to a person of ordinary skill in the art.

In response to the alert 1710, the operator may react at 1715 by, for example, sheltering in place, or attempting to locate the drone visually. In other words, the operator, uncertain of whether the drone is a cooperative or non-cooperative, may hurriedly scan the sky in an attempt to locate the drone. Further, at 1720, the operator may grab the reader, aim the reader at the drone in question, and wake-up the reader to send an encrypted signal requesting the drone or beacon provide its unique identification code.

At 1725, when the wake-up of the reader is triggered, it may transmit an encrypted signal requesting that any beacon within range prove that the drone on which the beacon is mounted is a friend. In response to receiving the encrypted signal from the reader, the beacon may wake up, and transmit a unique ID via a wireless signal before returning to a hibernation state at 1730.

At 1740, the reader may receive the unique identifier and compare the received identifier to an onboard database of known drones and communicate the result of the comparison overseas (e.g., “received code matches or is valid=friendly drone” or “received code does not match or is not valid=non-cooperative drone”). Additionally, information regarding the owner/pilot of the drone may be provided at 1740. Further, if the beacon provided GPS information, the location of the beacon may also be overlaid on a map associated with the reader's current location. If no legitimate code is received, the reader may continue to search.

At 1735, the operator may receive and review the result of the comparison provided by the reader.

Finally, equipped with the knowledge of whether the drone is a friend or foe, the operator may take appropriate action at 1745. For example, the operator may decide to tolerate or allow the drone to continue its flight path (“Friend”), contact the drone owner/pilot, ground other aircraft in the area to prevent collisions, search for the owner/pilot or institute countermeasures to relocate, disable, or destroy the drone.

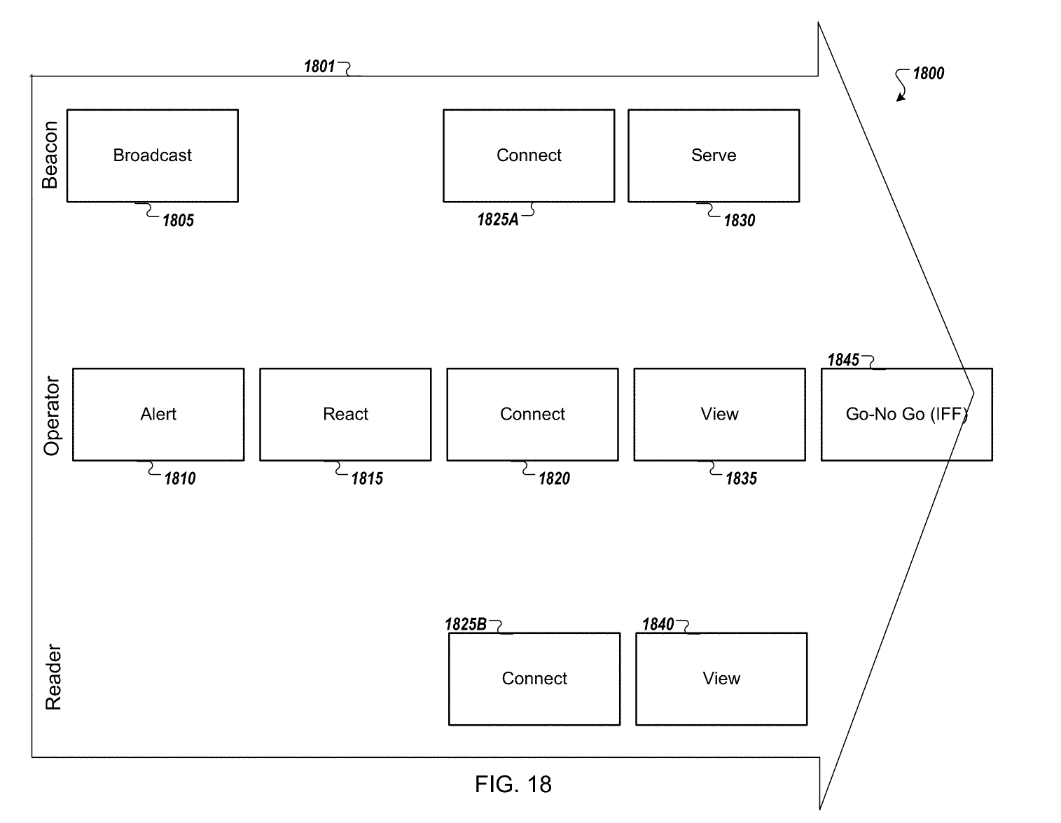

FIG. 18 illustrates another process 1800 of identifying if an inbound drone or other aerial platform is either a friend or a foe (IFF) using a system in accordance with an example implementation of the present application. As illustrated, the process 1800 involves a series of steps performed by three parties: 1. an operator/observer (e.g. operator/observer 5 discussed above), 2. a beacon mounted on the drone or other aerial platform, and 3. a reader associated with an IFF system (e.g., an IFF interface device 4 illustrated in FIGS. 1-7 discussed above). In FIG. 18, arrow 1801 illustrates the direction of process flow performed by each of the three parties during the process 1800. In some example implementations, the reader associated with the IFF system may be an omnidirectional reader, or may be a directional reader which must be pointed at the drone.

As illustrated, at 1805 the beacon continually broadcasts an encrypted signal containing its location and unique identifier. In parallel, at 1810, the operator becomes alerted or aware that the drone is overhead, nearby, or incoming. This alert may be received by visually seeing the drone, hearing the drone, receiving some sort of warning, receiving the beacon broadcasts via the reader, sensing the drone with a sensor (such as radar, for example), or any other process of receiving an alert that may be apparent to a person of ordinary skill in the art.

In response to the alert 1810, the operator may react at 1815 by, for example, sheltering in place, or attempting to locate the drone visually. In other words, the operator, uncertain of whether the drone is a cooperative or non-cooperative, may hurriedly scan the sky in an attempt to locate the drone. Further, at 1820, the operator may grab the reader, power the reader on, aim the reader at the drone in question, and wait for the reader connect to the beacon. At the 1825A/1825B, the reader may connect to the beacon as a Wi-Fi access point. If the reader is unable to connect or does not detect an access point, the reader may continue to search.

At 1830, the beacon may serve the reader with a stored website, containing information regarding the owner/pilot, current activity, and contact information. Further, if the beacon provides GPS information, the location of the beacon may also be overlaid on a map associated with the reader's current location.

At the 1840, the reader may receive the web site provided by the drone and may display it to the operator. At 1835, the operator may receive and review the website and determine if the drone is a friend or foe, or may contact the drone owner/pilot using the provided information.

Finally, equipped with the knowledge of whether the drone is a friend or foe, the operator may take appropriate action at 1845. For example, the operator may decide to tolerate or allow the drone to continue its flight path (“Friend”) may contact owner/operator, may contact authorities (e.g., Police, FAA, etc.) (“unknown/soft foe”), ground other aircraft in the area to prevent collisions, or institute countermeasures to relocate, disable, or destroy the drone.

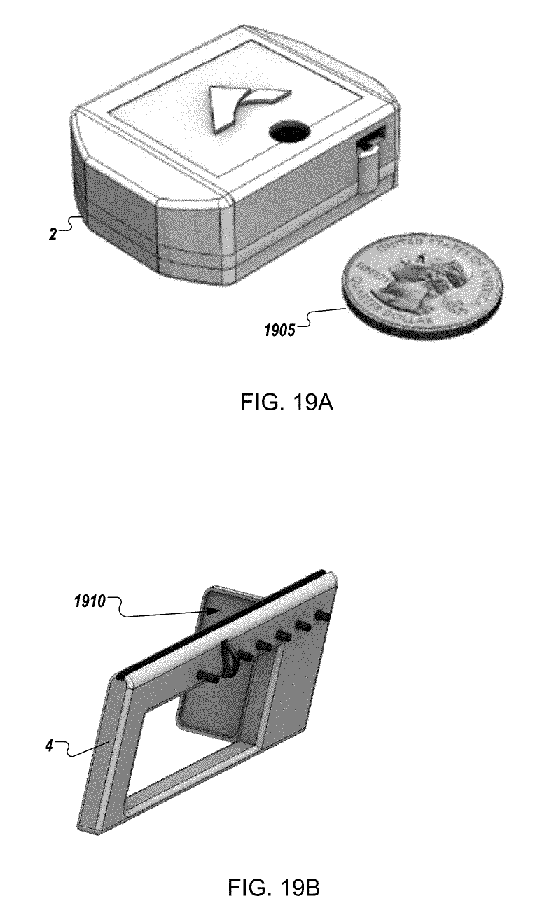

FIG. 19A illustrates a perspective view of a beacon 2 in accordance with an example implementation of the present application. In FIG. 19A, the beacon 2 is illustrated with a quarter 1905 for scale reference purposes. The beacon 2 may have different models, depending on the type of the sUAS to which it will be attached and its planned operational use. The data broadcast by any model of beacons 2 may be received and read by any reader. All models of beacon 2 may have built-in power and can also be connected to, and powered by, the main sUAS power.

Different models of beacon 2 may use different types of communication links. For consumer sUAS less than 2 lbs., the beacon 2 may be as light as possible with little maintenance necessary. For example, a lightweight (13 g) Bluetooth model may be used that has a non-rechargeable battery life of at least 2 years. For heavier, more capable consumer sUAS used by professional pilots the beacon 2 may be a Wi-Fi (or any other wireless protocol) model. This type of beacon 2 may allow the beacon 2 to store and share 128 kb of data containing all the info about the pilot, sUAS, flight, etc. The battery of this type of beacon may need to be recharged after 1 hour of flight, in the cases where the beacon 2 is not externally powered.

In the enterprise market for sUAS less than 55 lbs., the beacon 2 may have both Wi-Fi+GPS capabilities, in which the position is also transmitted, allowing an IFF enabled detection system to easily locate all beacon-enabled sUAS within the monitored airspace. Some beacon 2 modes may transmit the GPS data exclusively through Wi-Fi (or any other wireless protocol), while the other beacons 2 may also send the data through the cell phone network to a cloud-based server.

Any sUAS that co-exist with manned aircraft may need to communicate through an ADS-B protocol developed to avoid mid-air collisions. A beacon 2 may be equipped with an ADS-B transceiver that sends and receives position and identification data using the ADS-B. Further, in some example implementations, a unique IFF ID code may be appended to the ADS-B transmission, thereby utilizing the ADS-B frequency and protocol for IFF purposes.

FIG. 19B illustrates a perspective view of an IFF reader or IFF interface unit 4 in accordance with an example implementation of the present application. The IFF reader 4 may support any model of beacon and may include one of at least three models or types. The first type of IFF reader 4 may be a small, Omni-directional detector that receives data from all beacons within a particular range (up to 300 ft) and sends the received data through wireless (e.g., Wi-Fi, cellular, satellite communication, ZigBee, Bluetooth, or any other wireless frequency or protocol that might be apparent to a person of ordinary skill in the art) or wired connection to a server. The second type of IFF reader 4 (illustrated in FIG. 19B) may have a phone cradle 1910 that utilizes a portable computing device or smartphone (e.g., an Android smartphone, an Apple smart phone, or any other type of smartphone) that might be apparent to a person of ordinary skill in the art. The smart phone may provide a main user interface and internet connection. The phone-based user interface may display all beacons detected in the area. This type of IFF 4 reader may provide a high-gain, directional antenna, allowing it to detect beacons 200 ft., and in some cases, up to 2000 ft., away from the IFF reader 4. Both of these types of IFF readers 4 may be battery powered or may optionally have an external power capability. The third type of IFF reader 4 may be a complex directional antenna array assembly that provides 360 degree coverage with the capability to detect the location from where a beacon 2 is transmitting. In some example implementations, the IFF reader 4 may also include a PTZ camera and such integration of a PTZ camera enables visual confirmation and collection of live footage.

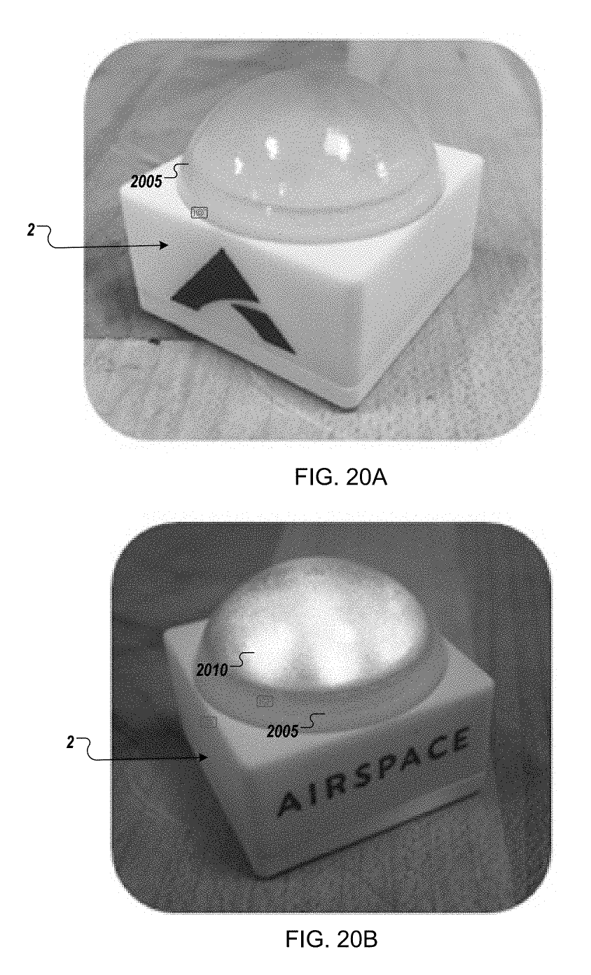

FIGS. 20A and 20B illustrate images of a beacon 2 in accordance with example implementations of the present application. As discussed above, the beacon 2 may have the capability to transmit wireless signals using a variety of methodologies including, Wi-Fi, cellular, satellite communication, ZigBee, Bluetooth, RF or any other wireless frequency or protocol that might be apparent to a person of ordinary skill in the art. Additionally, it may also have an integrated GPS sensing or other location detection capabilities. Further, as illustrated in FIGS. 20A and 20B, the beacon may also include visual or IR signaling capabilities. For example, the beacon 2 may include a transparent or translucent dome structure 2005 that covers one or more visible or IR emitting LEDs 2010 that may be controlled by the beacon 2 to emit a human or machine-readable pattern. In some example implementations control of the LEDs 2010 may be used to provide a final confirmation that a drone that is being communicated with using wireless communication signals is the same drone that can be visually observed. For example, a wireless communication signal may be used to instruct the beacon 2 to display a particular light or IR pattern, which can be visually recognized by an observer when performed by the beacon 2.

Further, in some example implementations control of the LEDs 2010 may be used to distinguish a drone that is being communicated with using wireless communication signals from other drones in the same visual proximity. Again, a wireless communication signal may be used to instruct the beacon 2 to display a particular light or IR pattern, which can be visually recognized by an observer or read by a machine when performed by the beacon 2 to identify which drone is being communicated with using the wireless communication signals. This can provide an additional layer of identification as discussed above with respect to FIGS. 13-18.

Example Computing Environment

FIG. 21 illustrates an example computing environment 2100 with an example computer device 2105 suitable for use in some example implementations. In some example implementations, the computer device 2105 may function as a beacon coupled to a UAS. In other example implementations, the computer device 2105 may function as the IFF system performing an IFF operation consistent with the example implementations of the present application. In still other example implementations, the computer device 2105 may function as an operator/observer associated device, or an IFF interface unit. In still other example implementations, the computer device 2105 may function as a drone owner/pilot associated device.

Computing device 2105 in computing environment 2100 can include one or more processing units, cores, or processors 2110, memory 2115 (e.g., RAM, ROM, and/or the like), internal storage 2120 (e.g., magnetic, optical, solid state storage, and/or organic), and/or I/O interface 2125, any of which can be coupled on a communication mechanism or bus 2130 for communicating information or embedded in the computing device 2105.

Computing device 2105 can be communicatively coupled to input/interface 2135 and output device/interface 2140. Either one or both of input/interface 2135 and output device/interface 2140 can be a wired or wireless interface and can be detachable. Input/interface 2135 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 2140 may include a display, television, monitor, printer, speaker, braille, or the like. In some example implementations, input/interface 2135 (e.g., user interface) and output device/interface 2140 can be embedded with, or physically coupled to, the computing device 2105. In other example implementations, other computing devices may function as, or provide the functions of, an input/interface 2135 and output device/interface 2140 for a computing device 2105. These elements may include, but are not limited to, well-known AR hardware inputs so as to permit a user to interact with an AR environment.

Examples of computing device 2105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 2105 can be communicatively coupled (e.g., via I/O interface 2125) to external storage 2145 and network 2150 for communicating with any number of networked components, devices, and systems, including one or more computing devices of the same or different configuration. Computing device 2105 or any connected computing device can be functioning as, providing services of, or referred to as a server, client, thin server, general machine, special-purpose machine, or another label.

I/O interface 2125 can include, but is not limited to, wired and/or wireless interfaces using any communication or I/O protocols or standards (e.g., Ethernet, 802.11xs, Universal System Bus, WiMAX, modem, a cellular network protocol, and the like) for communicating information to and/or from at least all the connected components, devices, and network in computing environment 2100. Network 2150 can be any network or combination of networks (e.g., the Internet, local area network, wide area network, a telephonic network, a cellular network, satellite network, and the like).

Computing device 2105 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 2105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 2110 can execute under any operating system (OS) (not shown), in a native or virtual environment. One or more applications can be deployed that include logic unit 2155, application programming interface (API) unit 2160, input unit 2165, output unit 2170, requesting unit 2175, identification unit 2180, verification unit 2185, reply unit 2190, and inter-unit communication mechanism 2195 for the different units to communicate with each other, with the OS, and with other applications (not shown).

For example, requesting unit 2175, identification unit 2180, verification unit 2185, and reply unit 2190 may implement part or all of each of the processes shown in FIGS. 13-18. The described units and elements can be varied in design, function, configuration, or implementation and are not limited to the descriptions provided.

In some example implementations, when information or an execution instruction is received by API unit 2160, it may be communicated to one or more other units (e.g., requesting unit 2175, identification unit 2180, verification unit 2185, and reply unit 2190). For example, the requesting unit 2175 may generate a request for identification or verification that is transmitted to another computing device via the network 2150. Further, the identification unit 2180 may retrieve a unique identifier in response to a received inquiry or request, received through the network 2150, and provide a reply including the unique identifier to the reply unit 2190 to send to another computing device through the network 2150. Further, the verification unit 2185 may evaluate a received reply or received request and generate verification information to indicate whether verification has been achieved.

In some instances, the logic unit 2155 may be configured to control the information flow among the units and direct the services provided by API unit 2160, input unit 2165, requesting unit 2175, identification unit 2180, verification unit 2185, and reply unit 2190 in some example implementations described above. For example, the flow of one or more processes or implementations may be controlled by logic unit 2155 alone or in conjunction with API unit 2160.

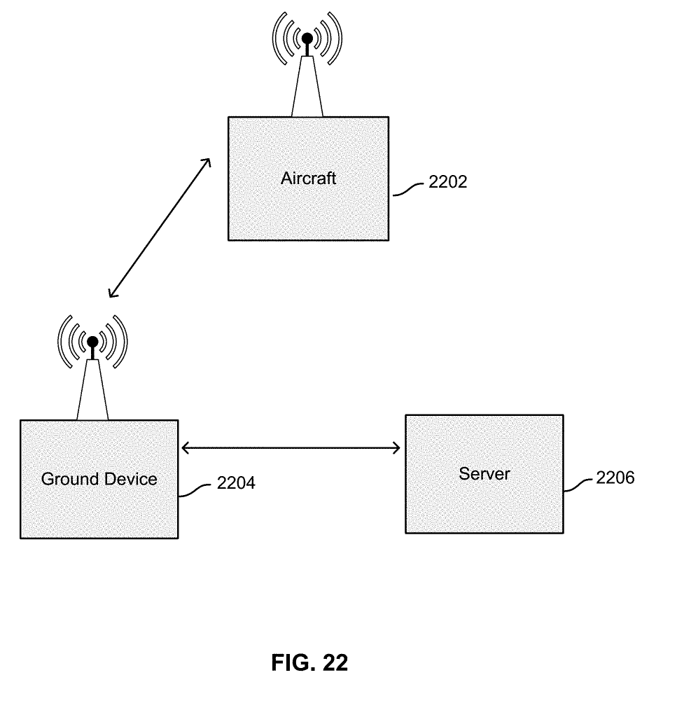

FIG. 22 is a block diagram illustrating an embodiment of a system for vehicle identifier authentication.

Aircraft 2202 (e.g., drone, UAV, helicopter, airplane, multirotor, or another type of aerial vehicle) broadcasts an identifier via a wireless signal that is received by ground device 2204. An example of the identifier is an SSID or any other transmitted identifier. This identifier may be utilized to verify the identity of the aircraft and its flight privileges and limitations within a certain airspace. In order to verify that the identifier of the aircraft is valid, ground device 2204 authenticates the identifier using information obtained (e.g., via a wired or wireless network) for aircraft 2202 from server 2206. For example, ground device 2204 obtains owner information, flight permissions, and a key that can be used to verify the broadcasted identifier of the aircraft. In some embodiments, aircraft 2202 includes one or more components of beacon 2 shown in previous figures. An example of aircraft 2202 includes drone 1 shown in previous figures. An example of ground device 2204 is IFF interface unit 4 or IFF Fixed Station 3 shown in previous figures. Examples of server 2206 include a server of IFF System 15, IFF Database and Backend 158, or IFF Ground Server 820 shown in previous figures.

In some embodiments, there is a need for a two-way trust between the ground device/server and the aircraft. For example, but not by way of limitation, the aircraft must be able to trust that the server that is transmitting policy information from a remote location such as at ground level is authentic, and is providing verified policy information. Conversely, the server and/or the ground device must have trust that the target aircraft that is receiving the policy information is credentialed. If two-way trust is not verified, the risk of transmission and reception is high.

The risks of misidentification or erroneous validation by either the aircraft or the ground transmitter and server, or both are substantial. For example, but not by way of limitation, an aircraft that accepts an unverified policy command could be receiving that information, which may result in the aircraft performing unauthorized commands, or commands provided by bad actors. Similarly, if a transmitter from the ground is unable to verify that the drone is credentialed, the transmitter from the ground may be providing policy or command information to an un-trusted party, or a bad actor that may use this information to avoid detection, or perform bad acts.

Moreover, the forgoing example implementations permit credentialing of the aircraft so as to provide grant privileges at two levels. At the group level, a drone may be identified as being associated with a trustworthy source (e.g., company, law enforcement, etc.). At an individual level, the drone may be verified as to his individual identification based on the information transmitted to the ground device, as explained in the forgoing example implementations.

In view of the relatively short distances between a small drone and the ground identification device, as well as the relatively short time that is available for the drone to implement the policy or commands provided by the ground identification device, an ad hoc authorization network connection is required to exchange information. This connection is essentially a peer to peer connection, as opposed to a connection provided via a mobile telecommunications network or via a website or general Internet communication. The network connection is specific to the drone associated with the identifying information, and the example implementation must be able to perform the connection and communication without connectivity to the Internet, as well as without needing to clear the communication via a database for security reasons. Given the short distance of peers from each other, communication is generally limited to direct communication by RF and light signals, as explained above. Further, in view of the nature of the motion of a drone, and the speeds of movements and pursuit, the communication must be real time, and delayed or asynchronous communication may result in the drone not being able to achieve its intended task, goal, or purpose.

Depending on the carrier or protocol, the communication may be performed by RF, Wi-Fi, Bluetooth, or other communication protocol for which real-time peer-to-peer communication may be performed in a secure manner. For example, but not by way of limitation, in a Wi-Fi network, TCP/IP or HTTP/HTTPS as would be understood by those skilled in the art may be used to implement a security protocol. Similar schemes may be employed for Bluetooth communications, as explained in further detail below.

Disclosed herein are systems and processes to provide secured wireless communication utilizing SSIDs conforming to the 802.11 standard as the mechanism of network packet identification. The system implements a rotating SSID which is utilized to address information packets over wireless networks. By frequently changing the SSID, the probability of it being discovered and exploited or spoofed is greatly reduced.

In order for this system to be reliable, the transmission of the identification is reliable and unique, but also predictable to known parties so that the identification can be tracked on the server-side to ensure that the wireless beacon was not changed or cloned, etc. The system utilizes a generation technique to periodically generate a token utilized for the temporary SSID.

FIG. 23 is a flowchart illustrating an embodiment of a process for generating an authenticatable identifier to be broadcasted. The process of FIG. 23 may be utilized by aircraft 2202 of FIG. 22 to generate and update its SSID periodically. For example, the process of FIG. 23 is repeated at a periodic interval. In some embodiments, the process of FIG. 23 is utilized by a vehicle to generate an authenticatable identifier of the vehicle to be transmitted.

At 2302, a secret is received. Examples of the secret information include an encryption key, a private key, a public key, a secret value, a password, a certificate, a credential, a hash function, a seed value, etc. The secret may be preprogrammed in a component of a vehicle (e.g., aircraft), provided via a local wired connection, received from a ground device (e.g., ground device 2204 of FIG. 22), or provided from a server via a network connection. The secret can be utilized to generate a token included in the authenticatable identifier that is to be broadcasted by the vehicle (e.g., aircraft).

At 2304, a synchronized time value is determined. In order to make sure the generated token will be predictably different at specific points in time, a shared value that changes predictably over time is to be utilized. For example, a system utilizes a digital time stamp at a given moment as a portion of the information used to generate the token for the authenticatable identifier (e.g., SSID). In applications where ephemeral (volatile) memory is used, non-permanent data is lost when the system is shut down or the battery voltage becomes too low. This may have the side effect of disrupting the timing as well. Because token generation for the SSID requires that the times be the same in order for SSIDs to match, it is important that time be maintained in the event of a system shutdown.

The synchronized time value may be determined using a synchronized clock of a vehicle (e.g., clock on aircraft is synchronized with clock on a receiving device), a GPS-based clock, a radio clock, an atomic clock, WWVB radio controlled clock, a real time clock, a network time-based clock, a satellite clock, a time obtained from a time server, a commonly seeded random number generator (e.g., generating a value at a preset consistent interval), etc. For example, it is possible to utilize GPS as a “point of truth” for time synchronization, although in this case the speed with which the SSID will be cycled may become inefficient. Another option is to place the device into a configuration mode every time it starts or charges. Another solution is to use an RTC (real time clock) circuit with a long backup battery. This implementation has the additional benefit of maintaining a more accurate clock by separating the time increments from the system's compute cycles as system voltage fluctuations can cause the clock speed of a system to shift which would cause the time signature used in the SSID to be incorrect.

At 2306, a token is generated using the synchronized time value and the received secret. In some embodiments, a value based on the synchronized time is combined (e.g., concatenated) with a value based on the secret (e.g., secret value), and the combined value is encrypted using a one-way encryption function. Examples of the one-way function include a hash function, a secret key encryption, asymmetric encryption (e.g., public key cryptography), etc. In some embodiments, a value based on the synchronized time value is encrypted using the secret received in 2302. For example, at least the synchronized time value is encrypted using a hash function or an encryption key received in 2302. In some embodiments, at least the synchronized time value is encrypted using symmetric encryption. By including an encrypted value in the token, a hacker attempting to spoof the token is unable to learn the pattern of token generation to accurately generate the next token.

At 2308, the token is combined with an assigned vehicle identifier to generate an authenticatable identifier. For example, the assigned vehicle identifier is a unique identifier that has been assigned to the corresponding vehicle. Examples of the assigned vehicle identifier include a serial number, a government issued identifier, a license number, a device identifier, and any other identifier that has been assigned to uniquely identify a vehicle/aircraft and/or a hardware component of the vehicle/aircraft. Combining the token with the assigned vehicle identifier may include concatenating them together to generate a combined value that becomes the authenticatable identifier to be transmitted. The authenticatable identifier is to be used in transmitting an identity of an associated aircraft. In some embodiments, the authenticatable identifier is utilized as an SSID of a wireless network advertised by the aircraft. For example, the SSID serves as both an authenticatable unique identifier of the aircraft and a name of a wireless network advertised by the aircraft that can be used to establish a wireless network connect with the aircraft.

FIG. 24 is a flowchart illustrating an embodiment of a process for verifying an authenticity of a transmitted authenticatable identifier. The process of FIG. 24 may be utilized by ground device 2204 of FIG. 22. For example, ground device 2204 uses the process of FIG. 24 to verify an identifier received from aircraft 2202 of FIG. 22.

At 2402, a transmitted identifier is received. In some embodiments, the received transmitted identifier is the authenticatable identifier generated in 1008 of FIG. 10. For example, the received identifier is an SSID of a wireless network advertised via Wi-Fi by an aerial vehicle.

At 2404, a token and an assigned vehicle identifier is obtained from the received identifier. For example, the received identifier has been formed from a combination of the token and the assigned vehicle identifier (e.g., unique identifier assigned to a vehicle that advertised the broadcasted identifier). Given a known relative ordering and fixed lengths of the token and the assigned vehicle identifier values, the token and the assigned vehicle identifier are extracted from the known locations within the received identifier.

At 2406, a secret associated with the assigned vehicle identifier is requested and received. For example, an inquiry is made to a server (e.g., server 2206 of FIG. 22) using a secure communication channel to obtain the secret associated with the assigned vehicle identifier. In some embodiments, obtaining the secret in 2406 is or is based on the secret that was received in 1002 of FIG. 10. For example, a database tracks information associated with a vehicle of the assigned vehicle identifier, such as owner information, flight permissions, etc. along with the associated secret. By keeping a copy of the secret at the associated vehicle and at a trusted remote party, the vehicle is able to provide its identity to the trusted remote party using the shared secret. This database may be locally stored or stored at a remote server. A device seeking to authenticate the received transmitted identifier is then able to query this database with the assigned vehicle identifier to not only obtain the associated secret to authenticate the received transmitted identifier, but is also able to obtain other associated information of the associated vehicle, such as owner information, flight permissions, etc. Examples of the secret include an encryption key, a private key, a public key, a secret value, a password, a certificate, a credential, a hash function, a seed value, etc.

At 2408, a comparison token is generated using the received secret. For example, the similar process utilized by a vehicle to generate the token that was included in the received transmitted identifier is used to generate the comparison token. This comparison token can then be compared with the obtained token to verify that the obtained token is valid. The comparison token is generated using a synchronized time value and the received secret. The synchronized time value may be determined using a synchronized clock of the receiver (e.g., clock of ground station, server, etc.) that is synchronized with a clock on the vehicle that sent the received transmitted identifier. Examples of the synchronized clock include a GPS-based clock, a radio clock, an atomic clock, WWVB radio controlled clock, a real time clock, a network time-based clock, a satellite clock, a time obtained from a time server, etc. In some embodiments, the same clock (e.g., obtain time from common remote time service) that was utilized to generate the obtained token is used to generate the comparison token. The synchronized time value may be a time value of when the transmitted identifier was transmitted or received. In some embodiments, a value based on the synchronized time is combined (e.g., concatenated) with a value based on the received secret (e.g., secret value), and the combined value is encrypted using the one-way encryption function. Examples of the one-way function include a hash function, a secret key encryption, asymmetric encryption (e.g., public key cryptography), etc. In some embodiments, a value based on the synchronized time value is encrypted using the secret received in 2406. For example, at least the synchronized time value is encrypted using a hash function or an encryption key received in 2406. In some embodiments, at least the synchronized time value is encrypted using symmetric encryption to generate the comparison token.

At 2410, the generated comparison token is compared with the obtained token and it is determined whether the generated comparison token matches the obtained token.

If at 2410 it is determined that the generated comparison token matches the obtained token, at 2412 it is determined that the received transmitted identifier is authentic. For example, it is determined that the vehicle that transmitted the received transmitted identifier is trusted to be assigned the assigned vehicle identifier included in the received transmitted identifier. In some embodiments, in response to this determination, a communication is established with the associated vehicle using the received broadcasted identifier in a network communication protocol (e.g., IEEE 802.11). For example, the received broadcasted identifier is an SSID that is used to establish a wireless Wi-Fi connection. In some embodiments, an associated flight permission is trusted in response to the determination in 2412.

If at 2410 it is determined that the generated comparison token does not match the obtained token, at 2414 it is determined that the received transmitted identifier is inauthentic. In some embodiments, in response, a notification and/or a report of the inauthenticity is provided. In some embodiments, in response, a patrol/interdiction aerial vehicle is deployed to monitor and/or capture the vehicle that broadcasted the inauthentic identifier. In some embodiments, the process is repeated at least one or more times to verify again that an identifier broadcasted by the vehicle is inauthentic before providing a report or performing a security measure.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for identifying an unmanned aerial vehicle (UAV) detected in a location, the system comprising:
a reader device, including:
a receiver configured to receive identification information and location information transmitted from the UAV; and
a transmitter configured to provide the received identification information and the received location information; and
wherein an the identification server includes:
a memory configured to store UAV registration information associated with the UAV;
a receiver configured to receive the identification information and the location information provided by the reader device; and
a processor configured to:
verify the UAV is authorized to be at a location based on the identification information and the location information; and
provide to the reader device a verification of the identification information based on the identification information, the location information, and the stored UAV registration information.

2. The system of claim 1, wherein the processor of the identification server is configured to provide the verification including by transmitting stored contact information identifying a user associated with the UAV to the reader device to facilitate communication between the reader device and the user associated with the UAV.

3. The system of claim 2, wherein the stored contact information connects the reader device to the user via one or more of: a voice call, a video call, a real-time text-based message exchange, or a delayed text-based message exchange.

4. The system of claim 2, wherein the processor of the identification server is configured to provide the stored contact information to the reader via an anonymized communication system that connects the reader device to the user without providing the stored contact information to the reader device.

5. The system of claim 1, wherein the received identification information includes location information associated with the UAV and the transmitter provides the received location information to the identification server.

6. The system of claim 5, wherein the processor of the identification server is configured to provide the verification including by comparing the received location information to stored location information associated with the UAV.

7. The system of claim 1, wherein the processor of the identification server is configured to provide the verification by automatically initiating a communication with a user associated with the UAV.

8. The system of claim 7, wherein the automatically initiated communication includes an automatically generated message providing location information sent to the user associated with the UAV and requesting the user to provide a confirmation of an operation of the UAV.

9. The system of claim 8, wherein the request that the user provide confirmation of the operation of the UAV includes a request to provide a secured identification code confirming an identity of the user.

10. The system of claim 1, wherein a user device associated with a user of the UAV is configured to transmit stored information to the identification server in response to a query from the identification server.

11. The system of claim 10, wherein user device is configured to automatically provide current status information of the UAV at regular intervals to the identification server.

12. The system of claim 11, wherein the current status information includes a current location of the UAV.

13. The system of claim 11, wherein the current status information includes an identity of a current pilot controlling the UAV.

14. The system of claim 13, wherein the processor of the identification server is configured to compare the identity of the current pilot with a registration information associated with the UAV.

15. The system of claim 1, wherein providing the verification includes determining the verification and the identification server is configured to provide an interdiction request in response to a failed verification.

16. The system of claim 15, wherein providing the interdiction request includes one or more of:
issuing warnings to the user associated device to have the UAV to exit the current location;
enacting radio frequency jamming; or hacking into a command and control link of the drone.

17. The system of claim 15, wherein providing the interdiction request includes deploying an interdiction platform to capture, remove, disable, or destroy the UAV.

18. The system of claim 1, wherein the processor is configured to receive a report regarding activities of the UAV and the stored UAV registration information to reflect a revocation of location access based on the received report.

19. A method for identifying an unmanned aerial vehicle (UAV) detected in a location, comprising:
receiving, at a reader device, an identification information and location information transmitted from the UAV;
providing the received identification information and the received location information to an identification server,
wherein the identification server, having access to UAV registration information associated with the UAV, is configured to receive the identification information and the location information provided by the reader device, configured to verify the UAV is authorized to be at a location based on the identification information and the location information, and is configured to provide to the reader device a verification of the identification information based on the identification information, the location information, and the stored UAV registration information.

20. A computer program product for identifying an unmanned aerial vehicle (UAV) detected in a location, the computer program product being embodied in a non-transitory computer readable storage medium and comprising computer instructions for:
receiving, at a reader device, an identification information and location information transmitted from the UAV;
providing the received identification information and the received location information to an identification server,
wherein the identification server, having access to UAV registration information associated with the UAV, is configured to receive the identification information and the location information provided by the reader device, configured to verify the UAV is authorized to be at a location based on the identification information and the location information, and is configured to provide to the reader device a verification of the identification information based on the identification information, the location information, and the stored UAV registration information.
